(19) United States
(12) Patent Application Publication
(10) Pub. No.: US 2011/0080132 A1
(43) Pub. Date: Apr. 7, 2011

(54) Stepping motor control circuit and analogue electronic watch

(76) Inventors: Kenji Ogasawara, Chiba-shi (JP); Kazumi Sakumoto, Chiba-shi (JP); Takanori Hasegawa, Chiba-shi (JP); Akira Takakura, Chiba-shi (JP); Saburo Manaka, Chiba-shi (JP); Keishi Honmura, Chiba-shi (JP); Hiroshi Shimizu, Chiba-shi (JP); Kosuke Yamamoto, Chiba-shi (JP)

(21) Appl. No.: 12/924,549

(22) Filed: Sep. 29, 2010

(30) Foreign Application Priority Data
Oct. 6, 2009 (JP) 2009-232072
Oct. 6, 2009 (JP) 2009-232073
Oct. 6, 2009 (JP) 2009-232074
Jul. 22, 2010 (JP) 2010-165288

(51) Int. Cl. H02P 8/38; G04B 19/04

(52) U.S. Cl. 318/696; 368/80

(57) ABSTRACT

The invention is intended to detect whether or not a stepping motor is rotated when being driven immediately after a pulse-down control accurately. A control unit drives the stepping motor with a first main drive pulse after the pulse-down control, and then drives the same with a correction drive pulse. A second detection circuit detects a state of rotation on the basis of a current flowing through the stepping motor when being driven with the correction drive pulse. The control circuit controls a drive pulse selection circuit so as to select the main drive pulse to be used for the next time on the basis of a result of detection of the second detection circuit. The drive pulse selection circuit rotates the stepping motor with the main drive pulse corresponding to a control signal.

### BACKGROUND OF THE INVENTION

1. Field of the Invention

The present invention relates to a stepping motor control circuit and an analogue electronic watch using the stepping motor control circuit.

2. Description of the Related Art

In the related art, a stepping motor including a stator having a rotor storage hole and a positioning portion for determining a stop position of a rotor, the rotor disposed in the rotor storage hole, and a coil, in which the rotor is rotated by causing the stator to generate a magnetic flux by supplying alternating signals to the coil and is stopped at a position corresponding to the positioning portion is used in an analogue electronic watch or the like.

As a control system of the stepping motor, a correction drive system configured as follows is used. That is, when the stepping motor is driven with a main drive pulse, whether the stepping motor is rotated or not is detected on the basis of a level of an induced signal generated by a rotation free vibrations of the stepping motor and, depending on-whether or not the stepping motor is rotated, the main drive pulse is changed to a pulse having a larger drive energy (pulse-up control) or to a pulse having a smaller drive energy (pulse-down control) or, alternatively, the stepping motor is rotated with a correction drive pulse having a larger pulse width than the respective drive pulses (for example, see JP-B-61-15385).

In WO2005/119377, when detecting the rotation of the stepping motor, a unit for comparatively discriminating a detected time-of-day and a reference time in addition to the detection of the level of the induced signal is provided. After having rotated the stepping motor with a main drive pulse P11, if the induced signal is lower than a predetermined reference threshold voltage Vcomp, a correction drive pulse P2 is output. Accordingly, the subsequent main drive pulse P1 is upgraded to a main drive pulse P12 having a larger energy than the main drive pulse P11 for driving the stepping motor. If the detected time-of-day when the stepping motor is rotated with the main drive pulse P12 is earlier than the reference time, the main drive pulse P12 is downgraded to the main drive pulse P11, to rotate the stepping motor with the main drive pulse P1 according to the load during the drive. Accordingly, the detection accuracy of the rotating state is improved in comparison with the invention disclosed in JP-A-61-15385, and the current consumption can be reduced.

However, when the detection of rotation is performed on the basis of the level of the induced signal, when the main drive pulse P1 having a large energy is downgraded to a main drive pulse having a smaller energy, the rotation is slowed with the change in drive energy and an induced signal VRs at a high level cannot be generated. Consequently, an induced signal exceeding the reference threshold voltage Vcomp is not generated even though the stepping motor has been rotated. Therefore, it may be erroneously detected as “non-rotation”, and hence a reliable rotation may not be achieved.

In JP-A-55-129785, an invention configured to detect a peak of a waveform of a current flowing through a drive coil of a stepping motor and change a drive pulse according to the level of the peak is disclosed. However, in JP-A-55-129785, any description is not given about a problem of the erroneous detection which may occur when the pulse is downgraded as described above.

In the case of an analogue electronic watch, a load applied is very small during a normal hand-moving operation other than an operation to change a calendar. However, when changing the calendar a load as high as double the load in the normal state or more is applied. The period required for the changing of the calendar is only several hours. Therefore, in the related art, an operation such as activating the stepping motor at a high pulse rank having a large energy, then downgrade the pulse rank by one level in a certain period of time such as several minutes, and output the correction drive pulse having a larger pulse width than the main drive pulse because the calendar load cannot be driven to upgrade the rank of the main drive pulse by a level is repeated for several hours.

In order to cope with a large load such as the calendar load while realizing the low power consumption in this system, it is necessary to prepare both a pulse row for low power consumption (with small energy difference between ranks) and a pulse row having a large energy for driving a heavy load.

If the fact that rotation could not be achieved with the main drive pulse P1 is reliably detected when the main drive pulse P1 is downgraded, the pulse can be upgraded after having driven with the correction drive pulse P2. However, if inertia of the rotor is high and hence the large induced signal VRs is supplied, the non-rotation may be determined to be rotation erroneously, so that there is a case where the hand-moving operation cannot be performed and hence delays of a time-of-day display may develop.

As the inventions described in JP-B-63-018148, JP-B-63-018149, and JP-B-57-018440, electronic watches having a stepping motor control circuit that drive the stepping motor with a minimum energy in the related art are configured to drive the stepping motor with a plurality of types of drive pulses.

With the stepping motor control circuit described above, a rotation detection circuit which detects whether an induced voltage generated by the stepping motor during the rotation exceeds the predetermined reference threshold voltage or not is provided.

If the stepping motor is determined not to be rotated on the basis of the result of detection by the rotation detection circuit, the main drive pulse is upgraded to a main drive pulse having a larger energy by one level (referred to as “pulse-up control” or “rank-up control”), and the above-described actions are repeated until the main drive pulse which is capable of rotating the stepping motor is achieved, thereby changing the main drive pulse to a main drive pulse which is reliably capable of rotating the stepping motor even though load fluctuations occur. The main drive pulse is changed to a main drive pulse having a smaller energy by one level at every certain period of time (referred to as “pulse-down” control or “rank-down control”), and whether the excessive pulse-up control is present or not is confirmed.

By performing the above-described actions alternatively using drive pulses having different polarities, a stable rotation is achieved while reducing the power consumption.

However, even though the drive with the pulse-down control cannot be achieved, the induced voltage exceeding the reference threshold voltage may be generated by the free vibrations of the rotor of the stepping motor, so that an erroneous determination as “rotated” may occur.

### SUMMARY OF THE INVENTION

It is an aspect of the present invention to perform a detection of rotation immediately after a pulse-down control accurately.

According to a first aspect of the invention, there is provided a stepping motor control circuit including: a rotation detection unit configured to detect whether or not the induced signal generated by a rotation of a stepping motor exceeds a predetermined reference threshold voltage; and a drive control unit configured to determine whether or not the stepping motor is rotated on the basis of a result of the detection by the rotation detection unit, change a main drive pulse into one of a plurality of types of the main drive pulses having energies different from each other on the basis of a result of determination, and control the drive of the stepping motor alternately with different polarities, wherein the drive control unit determines whether or not the stepping motor is rotated by being driven with the main drive pulse after a pulse-down control on the basis of the result of detection of the drive with the main drive pulse after the pulse-down control and the result of detection when being driven with a drive pulse which is output next to the main drive pulse after the pulse-down control and is capable of reliably rotating the stepping motor.

According to a second aspect of the invention, there is provided the stepping motor control circuit including a rotation detection unit configured to detect a state of rotation of a stepping motor, and a drive control unit configured to select any one of a plurality of main drive pulses having energies different from each other or a correction drive pulse having energy larger than the respective main drive pulse on the basis of a result of detection of rotation of the rotation detection unit and drive the stepping motor with the selected drive pulse, wherein the rotation detection unit detects the state of rotation on the basis of a current flowing through the stepping motor when the stepping motor is driven with the correction drive pulse immediately after having driven the same with the first main drive pulse after a pulse-down control, the drive control unit drives the stepping motor with the correction drive pulse immediately after having driven the same with the first main drive pulse after the pulse-down control and selects the main drive pulse for the next driving on the basis of the result of detection of the rotation detection unit when the stepping motor is driven with the correction drive pulse.

According to a third aspect of the invention, there is provided the stepping motor control circuit including a rotation detection unit configured to detect a state of rotation of a stepping motor, and a drive control unit configured to select either one of a plurality of main drive pulses having energies different from each other or a correction drive pulse having energy larger than the respective main drive pulses on the basis of a result of detection of rotation of the rotation detection unit, drive the stepping motor with the respective main drive pulses at polarities different from each other alternatively at a predetermined cycle and drive the stepping motor with the correction drive pulse at the same polarity as the main drive pulse immediately before in a same cycle, wherein when the stepping motor is determined to be rotated by being driven with the first main drive pulse after a pulse-down control, and if the stepping motor is still determined to be rotated by being driven with a first drive pulse which is capable of reliably rotating the stepping motor in the next cycle, the drive control unit selects the main drive pulse after the pulse-down control as the main drive pulse to be used for driving from the next cycle onward.

According to a fourth aspect of the invention, there is provided the stepping motor control circuit including: a rotation detection unit configured to detect whether or not an induced signal generated by a rotation of a stepping motor exceeds a predetermined reference threshold voltage; and a drive control unit configured to determine whether or not the stepping motor is rotated on the basis of a result of detection by the rotation detection unit, change a main drive pulse into one of a plurality of types of the main drive pulses having energies different from each other on the basis of a result of the determination, and control the drive of the stepping motor alternately with different polarities, wherein the drive control unit determines whether or not the stepping motor is rotated by being driven with the main drive pulse after a pulse-down control on the basis of the result of detection of the drive with the main drive pulse after the pulse-down control and the result of detection when being driven with a confirmation drive pulse having the same polarity as the main drive pulse after the pulse-down control and is capable of reliably rotating the stepping motor.

According to a fifth aspect of the invention, there is provide an analogue electronic watch having a stepping motor configured to rotate time hands, and a stepping motor control circuit configured to control the stepping motor, in which any one of the above-described stepping motor control circuits is used as the stepping motor control circuit.

According to the stepping motor control circuit in the invention, the detection of rotation immediately after the pulse-down control is performed accurately.

According to the analogue electronic watch in the invention, the accurate detection of rotation immediately after the pulse-down control is achieved. Therefore, an accurate clocking action is achieved.

### BRIEF DESCRIPTION OF THE DRAWINGS

FIG. 1 is a block diagram of an analogue electronic watch according to a first embodiment of the invention;

FIG. 2 is a configuration drawing of a stepping motor used in the analogue electronic watch according to the first embodiment of the invention;

FIGS. 3A to 3C are timing charts for explaining an action of a stepping motor control circuit and the analogue electronic watch according to the first embodiment of the invention;

FIG. 4 is a determination chart for explaining the action of the stepping motor control circuit and the analogue electronic watch according to the first embodiment of the invention;

FIG. 5 is a block diagram of an analogue electronic watch according to a second embodiment of the invention;

FIG. 6 is a configuration drawing of a stepping motor used in the analogue electronic watch according to the second embodiment of the invention;

FIGS. 7A to 7C are timing charts for explaining an action of a stepping motor control circuit and the analogue electronic watch according to the second embodiment of the invention;

FIG. 8 is a table for explaining the action of the stepping motor control circuit and the analogue electronic watch according to the second embodiment of the invention;

FIG. 9 is a flowchart showing the action of the stepping motor control circuit and the analogue electronic watch according to the second embodiment of the invention;

FIG. 10 is a block diagram of an analogue electronic watch according to a third and a fourth embodiments of the invention;

FIG. 11 is a configuration drawing of a stepping motor used in the analogue electronic watch according to the third and fourth embodiments of the invention;

FIG. 12 is a timing chart for explaining an action of a stepping motor control circuit and the analogue electronic watch according to the third embodiment of the invention;

FIG. 13 is a timing chart for explaining the action of the stepping motor control circuit and the analogue electronic watch according to the third embodiment of the invention;

FIG. 14 is a timing chart for explaining the action of the stepping motor control circuit and the analogue electronic watch according to the third embodiment of the invention;

FIG. 15 is a table for explaining the action of the stepping motor control circuit and the analogue electronic watch according to the third embodiment of the invention;

FIG. 16 is a table for explaining the action of the stepping motor control circuit and the analogue electronic watch according to the fourth embodiment of the invention;

FIG. 17 is a flowchart showing the stepping motor control circuit and the analogue electronic watch according to the third embodiment of the invention; and

FIG. 18 is a flowchart showing the stepping motor control circuit and the analogue electronic watch according to the fourth embodiment of the invention.

### DESCRIPTION OF THE PREFERRED EMBODIMENTS

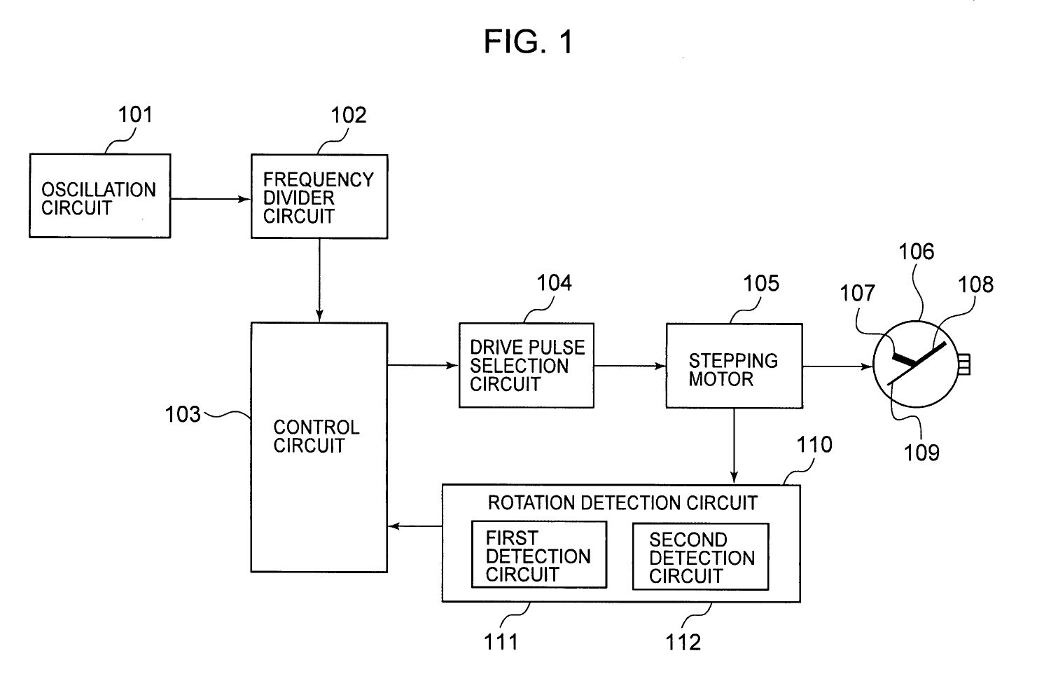

Referring now to FIG. 1 to FIG. 4, a motor control circuit according to a first embodiment of the invention and an analogue electronic watch will be described. In FIG. 1 to FIG. 4, the same components are designated by the same reference signs.

FIG. 1 is a block diagram of an analogue electronic watch using a motor control circuit according to the first embodiment of the invention showing an analogue electronic wrist watch.

In FIG. 1, an analogue electronic watch includes an oscillation circuit 101 configured to generate signals of a predetermined frequency, a frequency divider circuit 102 configured to divide the frequency of the signals generated by the oscillation circuit 101 and generate clock signals which serve as references of time counting, a control circuit 103 configured to control respective electronic circuit elements which constitute the electronic watch and control the change of a drive pulse, a drive pulse selection circuit 104 configured to select and output a drive pulse from a plurality of drive pulses for rotating a motor on the basis of a control signal from the control circuit 103, a stepping motor 105 configured to be rotated by the drive pulse from the drive pulse selection circuit 104, an analogue display unit 106 having time-of-day hands (three types; namely, an hour hand 107, a minute hand 108, and a second hand 109 in an example shown in FIG. 1) configured to be rotated by the stepping motor 105 and display the time of day, and a rotation detection circuit 110 configured to detect a state of rotation of the stepping motor 105 and output a detection signal which indicates the state of rotation.

The rotation detection circuit 110 includes a first detection circuit 111 and a second detection circuit 112 configured to detect the state of rotation of the stepping motor 105 and output the detection signal which indicates a result of detection.

When the stepping motor 105 is rotated with a main drive pulse P1 (except for a first main drive pulse P1 after the pulse-down control), the first detection circuit 111 detects an induced signal VRs generated by free vibrations of a rotor of the stepping motor 105, detects whether or not the induced signal VRs equal to or greater than a predetermined reference threshold voltage Vcomp is generated as the state of rotation, and outputs the detection signal which indicates the result of detection to the control circuit 103.

The second detection circuit 112 drives the stepping motor 105 with the first main drive pulse P1 after the pulse-down control, then drives the same with a correction drive pulse P2, detects a current Ipeak flowing through a drive coil 209 of the stepping motor 105 at a time point when a predetermined time t is elapsed from the start of driving with the correction drive pulse P2, detects whether or not the current Ipeak equal to or greater than a reference threshold current Icomp is generated as the state of rotation, and outputs the detection signal which indicates the result of detection to the control circuit 103.

The first detection circuit 111 and the second detection circuit 112 are both known circuits.

When the stepping motor is driven with the respective main drive pulses P1, the control circuit 103 determines whether the stepping motor 105 is rotated or not on the basis of the detection signal from the rotation detection circuit 110 and, depending on a load state, controls the drive pulse selection circuit 104 so as to change the main drive pulse to any one of the main drive pulses P1 or to forcedly rotate the stepping motor 105 with the correction drive pulse P2 having a larger drive energy than the respective main drive pulses P1.

When the stepping motor 105 is driven with the first main drive pulse P1 after the pulse-down control of the main drive pulse P1, the control circuit 103 controls the stepping motor 105 to be driven with the correction drive pulse P2 or the second detection circuit 112 to detect the rotation, so that whether the stepping motor 105 is rotated or not is detected, which will be described in detail later.

Here, the oscillation circuit 101 and the frequency divider circuit 102 constitute examples of a signal generating unit, and the analogue display unit 106 constitutes an example of a time-of-day display unit. The rotation detection circuit 110 constitutes an example of a rotation detection unit. The control circuit 103 constitutes an example of a control unit, and the control circuit 103, the drive pulse selection circuit 104, and the rotation detection circuit 110 constitute examples of the drive control unit.

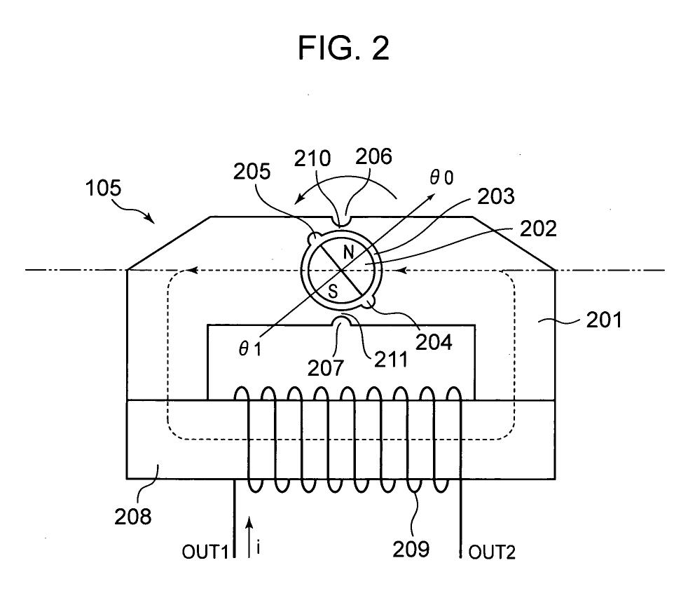

FIG. 2 is a configuration drawing of the stepping motor 105 which is used in the first embodiment of the invention, and shows an example of a stepping motor for a watch which is generally used in the analogue electronic watch.

In FIG. 2, the stepping motor 105 includes a stator 201 having a rotor storage through hole 203, a rotor 202 disposed in the rotor storage through hole 203 so as to be capable of rotating therein, a magnetic core 208 joined to the stator 201, and the drive coil 209 wound around the magnetic core 208. When the stepping motor 105 is used in the analogue electronic watch, the stator 201 and the magnetic core 208 are fixed to a bottom board (not shown) with screws or caulking (not shown) and are joined to each other. The drive coil 209 has a first terminal OUT1 and a second terminal OUT2.

The rotor 202 is magnetized in two polarities (S-pole and N-pole). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211. The saturable portions 210 and 211 are configured not to be magnetically saturated by a magnetic flux of the rotor 202 and to be magnetically saturated when the coil 209 is excited so that reluctance is increased. The rotor storage through hole 203 is formed into a circular hole shape having a plurality of (two in this embodiment) semicircular notched portions (inner notches) 204 and 205 integrally formed at opposed portions of the through hole having a circular contour.

The notched portions 204 and 205 constitute positioning portions for positioning a stop position of the rotor 202. In a state in which the drive coil 209 is not excited, the rotor 202 is stably stopped at a position corresponding to the above-described positioning portions, in other words, at a position where an axis of magnetic pole A of the rotor 202 extends orthogonally to a segment connecting the notched portions 204 and 205 (a position forming an angle θ0 with respect to the direction X of magnetic flux flowing through the stator 201) as shown in FIG. 2.

When the drive pulse selection circuit 104 supplies a square-wave drive pulse having one of the polarities to between the terminals OUT1 and OUT2 of the drive coil 209 (for example, plus for the first terminal OUT1 side and minus for the second terminal OUT2 side), and feeds a current i in the direction indicated by an arrow in FIG. 2, a magnetic flux in the direction of an arrow of a broken line is generated in the stator 201. Accordingly, the saturable portions 210 and 211 are saturated, and the reluctance is increased, and then the rotor 202 rotates in the direction indicated by a solid line arrow in FIG. 2 by 180° by a mutual action between a magnetic pole generated in the stator 201 and a magnetic pole of the rotor 202, and stops stably at an angular position θ1.

Subsequently, when the drive pulse selection circuit 104 supplies square-wave drive pulses having opposite polarities to the terminals OUT1 and OUT2 of the drive coil 209 (minus for the first terminal OUT1 side and plus for the second terminal OUT2 side, so that the polarity is reversed from the driving described above), and feeds a current in the opposite direction from that indicated by the arrow in FIG. 2, a magnetic flux in the opposite direction from that indicated by the arrow of the broken line is generated in the stator 201. Accordingly, the saturable portions 210 and 211 are saturated first, and then the rotor 202 rotates in the same direction as that described above by 180° by a mutual action between the magnetic pole generated in the stator 201 and the magnetic pole of the rotor 202, and stops stably at an angular position θ1.

From then on, the operation as described above is repeatedly performed by supplying signals having different polarities (alternating signals) to the drive coil 209, so that the rotor 202 is rotated continuously in the direction indicated by the solid line arrow by 180° each. When the rotor 202 is driven continuously with the drive pulses having the same polarity, the rotor 202 does not rotate with the drive pulses having the same polarity from the second time onward, but rotates continuously by being driven with the drive pulses having different polarities supplied alternatively.

In the first embodiment of the invention, a plurality of types of the main drive pulses P1 that drive a load in the normal state and have different drive energies from each other, and the correction drive pulse P2 used when the drive energy is larger than the respective main drive pulses P1 and hence the stepping motor 105 cannot be rotated with the main drive pulse P1 are used as the drive pulses.

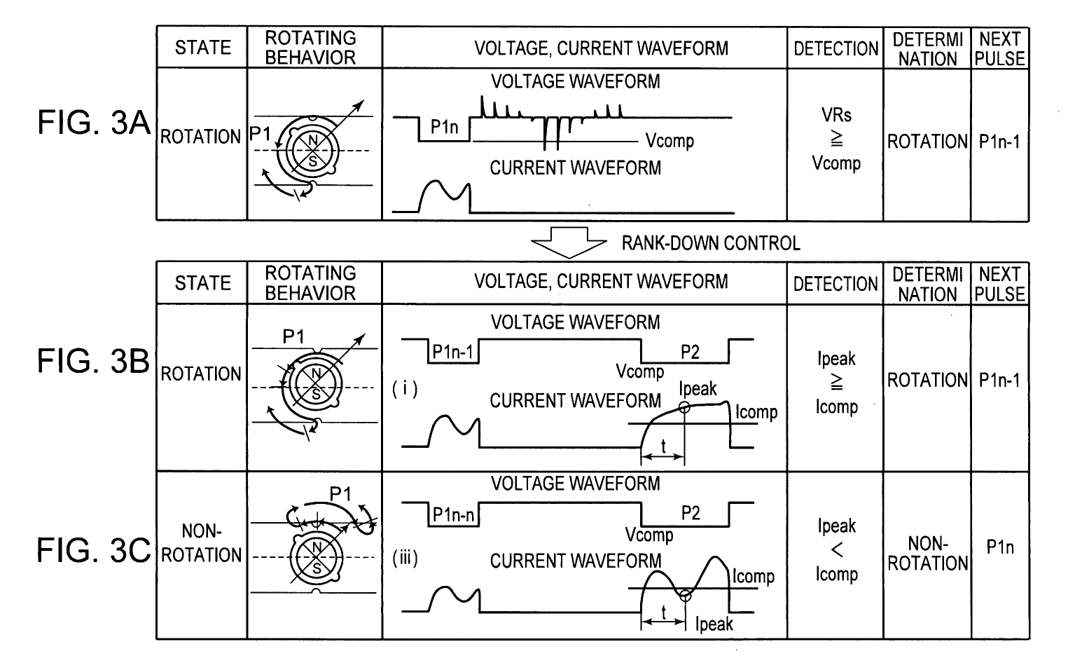

FIGS. 3A to 3C are timing charts for explaining the operation of the first embodiment of the invention, in which FIG. 3A is a timing chart showing a case where the stepping motor 105 is normally rotated by being driven with a main drive pulse P1n, and then a main drive pulse P1 (n−1) which is downgraded from the main drive pulse P1n by a rank is selected as the main drive pulse P1 for the next driving, FIG. 3B is a timing chart showing a case where the stepping motor 105 is normally rotated by being driven with the first main drive pulse P1 (n−1) after the pulse-down control, and FIG. 3C is a timing chart showing a case where the stepping motor 105 is not normally rotated by being driven with the first main drive pulse P1 (n−1) after the pulse-down control.

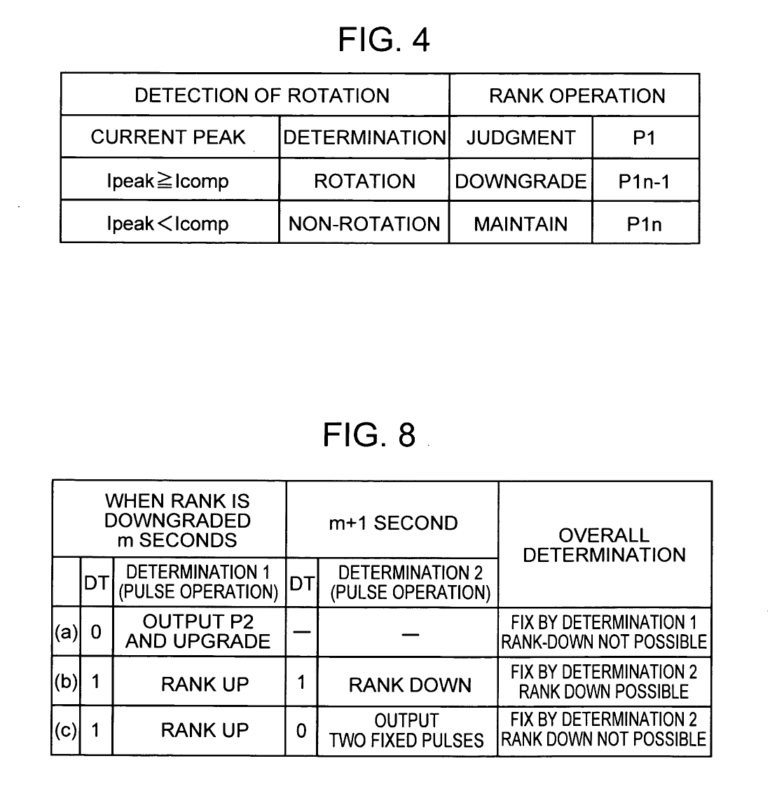

FIG. 4 is a table showing a relationship between the result of detection of rotation and a rank operation (pulse-down control, pulse-up control or rank maintaining operation), which are stored in a storage unit (not shown) in the control circuit 103. The control circuit 103 performs the rank operation on the basis of the detection signal from the rotation detection circuit 110 referring to the table.

Referring now to FIG. 1 to FIG. 4, the operation in the first embodiment of the present invention will be described.

The control circuit 103 performs a clocking action on the basis of the clock signals from the frequency divider circuit 102, and outputs a control signal to the drive pulse selection circuit 104 at a predetermined drive timing. The drive pulse selection circuit 104 selects the main drive pulse P1 corresponding to the control signal and rotates the stepping motor 105. When the stepping motor 105 rotates normally, the time-of-day hands 107 to 109 are driven at predetermined timings by the stepping motor 105, and the current time of day is displayed by the analogue display unit 106.

In the rotation detection circuit 110, if the stepping motor 105 is driven by the main drive pulse P1 other than the first main drive pulse P1 after the pulse-down control, the first detection circuit 111 detects the induced signal VRs which is generated by the free vibrations of the stepping motor 105, and outputs the detection signal indicating whether or not the induced signal VRs equal to or greater than the predetermined reference threshold voltage Vcomp to the control circuit 103.

When the stepping motor 105 is rotated, as shown as a rotating behavior in FIG. 3A, if the stepping motor 105 is driven by the main drive pulse P1n, the rotor 202 rotates in the direction indicated by an arrow and, when the driving with the main drive pulse P1n (the driving time is P1) is finished, generation of the free vibrations of the rotor 202 in the direction indicated by an arrow is followed. In a rotation detection term immediately after the driving with the main drive pulse P1n, the first detection circuit 111 compares the induced signal VRs generated by the free vibrations with the reference threshold voltage Vcomp and outputs a detection signal indicating that the induced signal VRs equal to or greater than the reference threshold voltage Vcomp is detected. The control circuit 103 determines that the stepping motor is rotated on the basis of the detection signal, and selects a main drive pulse P1 (n−1) which is a pulse downgraded from the main drive pulse P1n by one rank as the main drive pulse P1 used for the next driving. The driving for the next time is performed with the main drive pulse P1 (n−1).

Upon receipt of a detection signal indicating that the induced signal VRs is not equal to or greater than the predetermined reference threshold voltage Vcomp from the first detection circuit 111, the control circuit 103 determines that the stepping motor 105 is not rotated, and controls the drive pulse selection circuit 104 so as to drive the stepping motor 105 with the correction drive pulse P2. The drive pulse selection circuit 104 drives the stepping motor 105 with the correction drive pulse P2 and forcedly rotates the same, thereby moving the time-of-day hands 107 to 109. Subsequently, the control circuit 103 selects the main drive pulse P1 (n+1) which is upgraded by one rank as the main drive pulse P1 for the next driving.

In contrast, when downgrading the main drive pulse P1n to the main drive pulse P1n as shown in FIG. 3A and then driving the stepping motor 105 with the first main drive pulse P1 (n−1) after the pulse-down control as shown in FIGS. 3B and 3C, the control circuit 103 drives the stepping motor 105 with the first main drive pulse P1 (n−1), and then drives the same with the correction drive pulse P2 having the same polarity as the main drive pulse P1 (n−1) irrespective of whether the stepping motor 105 is rotated with the main drive pulse P1 (n−1) or not. In this case, the stepping motor 105 is driven absolutely with the correction drive pulse P2 having the same polarity without performing the detection of rotation immediately after the driving of the main drive pulse P1 (n−1) by the first detection circuit 111.

At the time of rotating the stepping motor 105 with the correction drive pulse P2, the second detection circuit 112 detects the current Ipeak flowing in the drive coil 209 at a timing when the predetermined time t is elapsed from the start of driving with the correction drive pulse P2, and outputs the detection signal indicating whether the current Ipeak is equal to or greater than the reference threshold current Icomp or not to the control circuit 103.

As shown in FIG. 3B, if the stepping motor 105 is not rotated with correction drive pulse P2, the current Ipeak becomes equal to or greater than the reference threshold current Icomp. In this case, the control circuit 103 determines that the stepping motor 105 is rotated with the main drive pulse P1 (n−1). Therefore, if the current Ipeak is equal to or greater than the reference threshold current Icomp as shown in FIG. 4, the control circuit 103 determines that the stepping motor 105 can be rotated with the main drive pulse P1 (n−1), and controls to select the main drive pulse P1 (n−1) after the pulse-down control as the main drive pulse P1 for the next driving and drive the stepping motor 105 with the selected main drive pulse P1 (n−1). From then onward until the next rank operation, the stepping motor 105 is driven with the main drive pulse P1 (n−1) after the pulse-down control.

On the other hand, as shown in FIG. 3C, if the stepping motor 105 is rotated with the correction drive pulse P2, the current Ipeak becomes smaller than the reference threshold current Icomp. In this case, the control circuit 103 determines that the stepping motor 105 is not rotated with the main drive pulse P1 (n−1). Therefore, when the current Ipeak is smaller than the reference threshold current Icomp as shown in FIG. 4, the control circuit 103 determines that the stepping motor 105 cannot be rotated with the main drive pulse P1 (n−1), and controls to select the main drive pulse P1n before the pulse-down control as the main drive pulse P1 for the next driving. From then onward until the next rank operation, the stepping motor 105 is driven with the main drive pulse P1n before the pulse-down control.

As described thus far, the stepping motor control circuit according to the first embodiment of the invention includes a rotation detection unit configured to detect a state of rotation of a stepping motor, and a drive control unit configured to select any one of a plurality of main drive pulses having energies different from each other or a correction drive pulse having energy larger than the respective main drive pulse on the basis of a result of detection of rotation of the rotation detection unit and drive the stepping motor with the selected drive pulse, wherein the rotation detection unit detects the state of rotation on the basis of a current flowing through the stepping motor when the stepping motor is driven with the correction drive pulse immediately after having been driven with the first main drive pulse after a pulse-down control, the drive control unit drives the stepping motor with the correction drive pulse immediately after having driven the same with the first main drive pulse after the pulse-down control and selects the main drive pulse for the next driving on the basis of the result of detection of the rotation detection unit when the stepping motor is driven with the correction drive pulse.

Therefore, since the stepping motor 105 is configured to be driven with the correction drive pulse P2 after having been driven with the first main drive pulse P1 after the pulse-down control and select the main drive pulse P1 for the next driving on the basis of the rotation detection result when the stepping motor is driven with the correction drive pulse P2, whether or not the stepping motor is rotated by being driven with the first main drive pulse P1 after the pulse-down control is detected accurately.

Since whether the stepping motor is rotated by being driven with the first main drive pulse P1 after the pulse-down control or not can be detected accurately, reliable rotation is achieved.

Even when the energy difference between the ranks of the main drive pulse P1 is, large, and the induced signal VRs exceeding the reference threshold voltage Vcomp cannot be detected when being driven with the first main drive pulse P1 after the pulse-down control even though the stepping motor has been rotated, the accurate detection of rotation is achieved while preventing an erroneous detection of rotation, so that the reliable rotation of the stepping motor is achieved.

When driving the stepping motor with the first main drive pulse P1 after the pulse-down control, the stepping motor is configured to be driven with the correction drive pulse P2 automatically without performing the detection of rotation on the basis of the induced signal VRs. Therefore, the reliable rotation is achieved when rotating the stepping motor immediately after the pulse-down control. At this time, the detection of rotation is performed on the basis of the current flowing through the drive coil 209 at the time of driving with the correction drive pulse P2 and, on the basis of the result of detection, whether or not the rotation is achieved with the main drive pulse P1 is determined. Therefore, the detection of rotation is achieved accurately.

When driving the stepping motor with the first main drive pulse P1 after the pulse-down control, the stepping motor is configured to be driven with the correction drive pulse P2 automatically without performing the detection of rotation on the basis of the induced signal VRs. Therefore, the reliable rotation is achieved when rotating the stepping motor immediately after the pulse-down control.

Also, the number of ranks of the main drive pulse P1 can be pared to the minimum, so that reduction of the scale of an integrated circuit (IC) and cost reduction are achieved.

According to the analogue electronic watch in the invention, the accurate detection of the state of rotation immediately after the pulse-down control is enabled. Therefore, the accurate clocking action is achieved. Consequently, the accurate clocking action without delay in time-of-day displayed by the time-of-day hands 107 to 109 is achieved.

In the embodiment described above, the pulse-down control of the main drive pulse P1 may be preformed when one revolution of the stepping motor 105 is achieved with the main drive pulse P1. However, the pulse-down control may be performed when the stepping motor 105 could be rotated with the main drive pulse P1 having the same drive energy continuously by a predetermined number of times, on the basis of whether or not the time point of generation of the induced signal VRs is earlier than a reference time-of-day as in the invention disclosed in WO2005/119377, or when it is determined to have an additional coverage in the drive energy on the basis of a pattern of generation of the induced signal VRs exceeding the reference threshold voltage Vcomp within a detection period, and so on as various possible modifications.

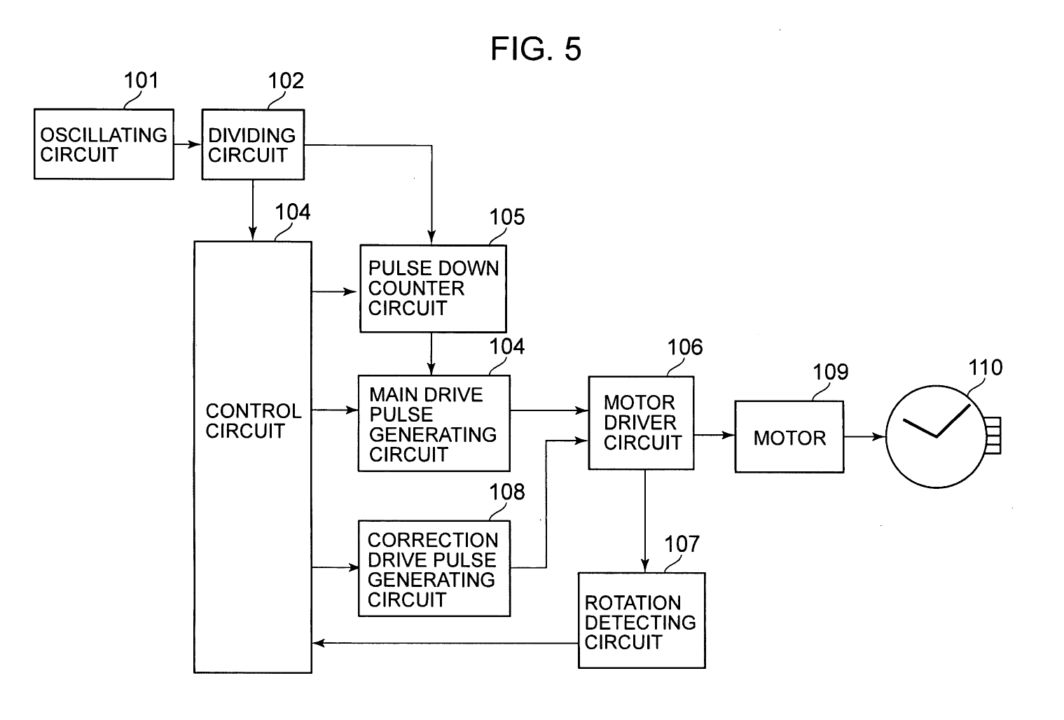

Referring now to FIG. 5 to FIG. 9, a stepping motor control circuit according to a second embodiment of the invention and an analogue electronic watch will be described. In FIG. 5 to FIG. 9, the same components are designated by the same reference signs.

FIG. 5 is a block diagram of the analogue electronic watch employing the stepping motor control circuit used in the second embodiment of the invention showing an analogue electronic wrist watch.

In FIG. 5, the analogue electronic watch includes an oscillation circuit 101 configured to generate signals of a predetermined frequency, a frequency divider circuit 102 configured to divide the frequency of the signals generated in the oscillation circuit 101 and generate clock signals which serve as references of time counting, a control circuit 103 configured to control respective electronic circuit elements which constitute the electronic watch and control the change of a drive pulse, a pulse down counter circuit 105 configured to output a pulse down signal for downgrading a main drive pulse P1 every time when the clock signal from the frequency divider circuit 102 is counted for a predetermined time period, and start the clocking action again after having reset a counted value in response to a reset signal from the control circuit 103.

The analogue electronic watch includes a main drive pulse generating circuit 104 configured to select a main drive pulse P1 from among a plurality of the main drive pulses P1 for rotating a motor on the basis of a control signal from the control circuit 103 and output the same, a correction drive pulse generating circuit 108 configured to output a correction drive pulse P2 for forcedly rotating of a stepping motor 109 on the basis of the control signal from the control circuit 103, a motor drive circuit 106 configured to rotate the stepping motor 109 in response to the main drive pulse P1 from the main drive pulse generating circuit 104 and the correction drive pulse P2 from the correction drive pulse generating circuit 108, the stepping motor 109, an analogue display unit 110 having time-of-day hands configured to be rotated by the stepping motor 109 and display the time of day, and a rotation detection circuit 107 configured to detect an induced signal VRs generated by free vibrations of the stepping motor 109 in a predetermined rotation detection term DT and output a detection signal indicating a state of rotation indicating whether the induced signal VRs exceeding a predetermined reference threshold voltage Vcomp is generated or not.

The control circuit 103 also has a reset function to reset the pulse down counter circuit 105 under certain conditions and restart a counting action from an initial value and a function to determine whether the stepping motor 109 is rotated or not on the basis of the detection signal from the rotation detection circuit 107. As described later, the rotation detection term DT for detecting the state of rotation of the stepping motor 109 is provided in the train of a masking term (the term when the induced signal VRs is not detected) immediately after the rotation IT.

The rotation detection circuit 107 has the same configuration as the rotation detection circuit described in JP-B-61-15385, and is configured to detect the induced signal VRs exceeding the predetermined reference threshold voltage Vcomp if a rotor of the stepping motor 109 moves at a speed higher than a certain speed as in the case where the stepping motor 109 is rotated and not to detect the induced signal VRs exceeding the reference threshold voltage Vcomp if the rotor of the stepping motor 109 does not move at the speed higher than the certain speed as in the case where the stepping motor 109 is not rotated.

The oscillation circuit 101 and the frequency divider circuit 102 constitute a signal generating unit, and the analogue display unit 110 constitutes a time-of-day display unit. The control circuit 103 constitutes a control unit and the rotation detection circuit 107 constitutes a rotation detection unit. The main drive pulse generating circuit 104 and the correction drive pulse generating circuit 108 constitute a drive pulse generating unit. The motor drive circuit 106 constitutes a motor drive unit. The oscillation circuit 101, the frequency divider circuit 102, the pulse down counter circuit 105, the control circuit 103, the main drive pulse generating circuit 104, the correction drive pulse generating circuit 108, and the motor drive circuit 106 constitute a drive control unit.

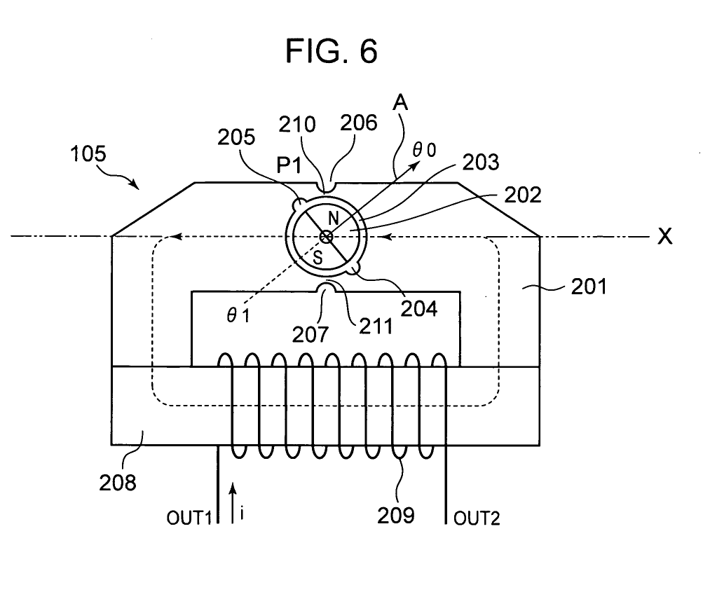

FIG. 6 is a configuration drawing of the stepping motor which is used in the second embodiment of the invention, and shows an example of a stepping motor for a watch which is generally used in the analogue electronic watch.

In FIG. 6, the stepping motor 109 includes a stator 201 having a rotor storage through hole 203, a rotor 202 disposed in the rotor storage through hole 203 so as to be capable of rotating therein, a magnetic core 208 joined to the stator 201, and a drive coil 209 wound around the magnetic core 208. When the stepping motor 109 is used in the analogue electronic watch, the stator 201 and the magnetic core 208 are fixed to a bottom board (not shown) with screws or caulking (not shown) and are joined to each other. The drive coil 209 has a first terminal OUT1 and a second terminal OUT2.

The rotor 202 is magnetized in two polarities (S-pole and N-pole). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the drive coil 209 is excited so that a reluctance is increased. The rotor storage through hole 203 is formed into a circular hole shape having a plurality of (two in this embodiment) semicircular notched portions (inner notches) 204 and 205 integrally formed at opposed portions of the through hole having a circular contour.

The notched portions 204 and 205 constitute positioning portions for positioning a stop position of the rotor 202. In a state in which the drive coil 209 is not excited, the rotor 202 is stably stopped at a position corresponding to the above-described positioning portions, in other words, at a position (position at an angle of θ0) where an axis of magnetic pole A of the rotor 202 extends orthogonally to a segment connecting the notched portions 204 and 205 as shown in FIG. 6.

If a square-wave drive pulse having one of the polarities (for example, plus on the side of the first terminal OUT1 and minus on the side of the second terminal OUT2) is supplied between the terminals OUT1 and OUT2 of the drive coil 209 from the motor drive circuit 106 and a current i is flowed in the direction indicated by an arrow in FIG. 6, a magnetic flux in the direction indicated by arrows in a broken line is generated in the stator 201. Accordingly, the saturable portions 210 and 211 are saturated, and the reluctance is increased, and then the rotor 202 rotates in the direction indicated by an arrow in FIG. 6 by 180° by a mutual action between a magnetic pole generated in the stator 201 and a magnetic pole of the rotor 202, and the axis of magnetic pole A stops stably at an angular position θ1 with respect to an X-axis. The direction of rotation (counterclockwise rotation in FIG. 6) for causing the stepping motor 109 to rotate and putting the same into a normal action (hand-moving operation because the watch in this embodiment is an analogue electronic watch) is defined to be a normal direction and the reverse direction (clockwise direction) is defined to be a reverse direction.

In the next drive cycle, if a drive pulse having opposite polarities (minus on the side of the first terminal OUT1 and plus on the side of the second terminal OUT2, so that the polarity is reversed from the driving described above) is supplied to the terminals OUT1 and OUT2 of the drive coil 209 from the motor drive circuit 106 and a current is flowed in the direction opposite from the direction indicated by the arrow in FIG. 6, a magnetic flux in the direction opposite from the direction indicated by the arrows in the broken line is generated in the stator 201. Accordingly, the saturable portions 210 and 211 are saturated first, and then the rotor 202 rotates in the same direction as that described above by 180° by the mutual action between the magnetic pole generated in the stator 201 and the magnetic pole of the rotor 202, and the axis of magnetic pole A stops stably at an angular position θ0 with respect to the X-axis.

From then onward, the above-described action is performed repeatedly by supplying the drive coil 209 with the main drive pulses having different polarities (alternating signals) alternately at every drive cycle, so that the rotor 202 is rotated continuously in the direction indicated by the arrow by 180° each. In this manner, the continuous rotation is achieved by driving alternatively with the drive pulses having different polarities. In contrast, if the drive pulses having the same polarities are used for the continuous rotation, the rotor 202 rotates with the first drive pulse, but does not rotate with the drive pulses from the second drive pulse onward.

In this embodiment, a plurality of types of main drive pulses P1n and a correction drive pulse P2 having energies different from each other are used as the drive pulses as described later. A rank n of the main drive pulse P1n has a plurality of ranks from the minimum value 1 to a maximum value m (m=4 in this embodiment), and the energy of the drive pulse increases with increase of the value n. The correction drive pulse P2 is a large energy pulse which is able to rotate an excessive load, and is configured to have energy larger than the respective main drive pulses P1. In this embodiment, the main drive pulse P1 uses the square-wave main drive pulse, so that the drive energy can be changed by changing a pulse width.

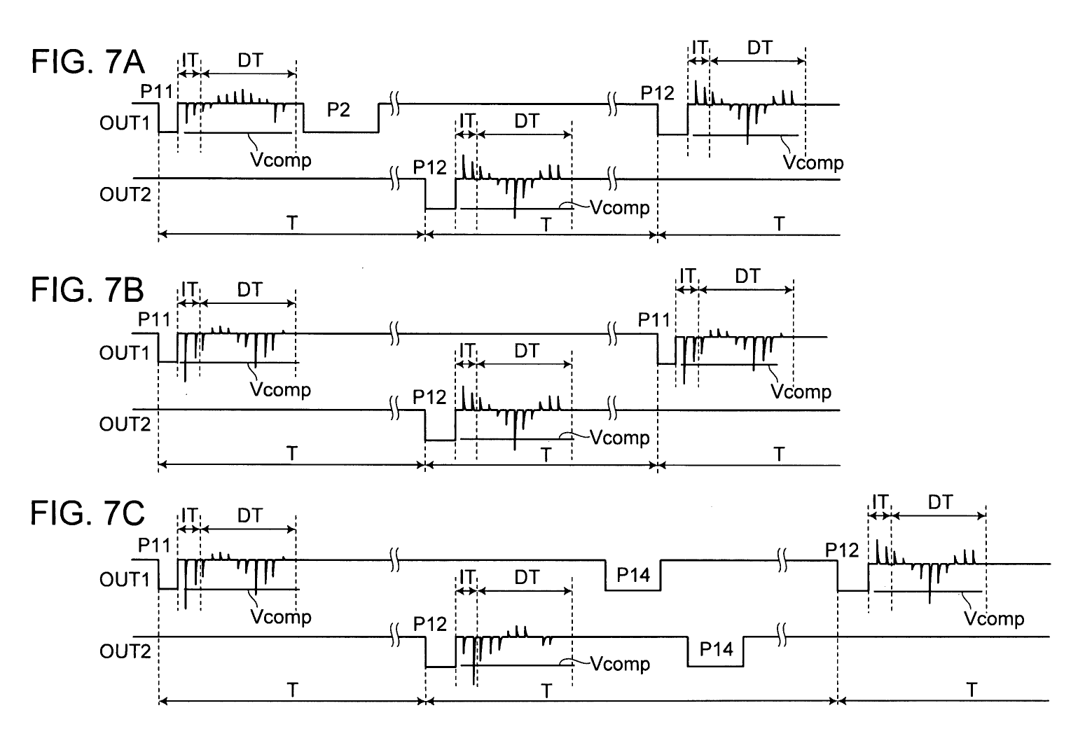

FIGS. 7A to 7C are timing charts according to the second embodiment of the invention. FIG. 7A is a timing chart showing a case where the stepping motor 109 is not rotated with the main drive pulse P1 immediately after having downgraded the main drive pulse P1, FIG. 7B is a timing chart showing a case where the fact that the stepping motor 109 is rotated with the main drive pulse P1 immediately after the pulse-down control is correctly detected, and FIG. 7C is a timing chart showing a case where the stepping motor 109 is erroneously detected to have been rotated even though it is not rotated with the main drive pulse P1 immediately after the pulse-down control. In these drawings, the polarities of the drive pulses to be applied to the terminals OUT1 and OUT2 of the drive coil 209 are also shown.

A masking term IT is provided immediately after a rotating period in which the stepping motor 109 is rotated with the main drive pulse P1, and a rotation detection term DT for detecting whether the stepping motor 109 is rotated or not is provided immediately after the masking term IT. The masking term IT is a period provided for eliminating an erroneous detection due to the effects of noises or the like and is a period in which the induced signal VRs generated by the stepping motor 109 is not detected.

In FIGS. 7A to 7C, a timing after the stepping motor 109 is rotated with a main drive pulse P12, then the control circuit 103 controls the main drive pulse generating circuit 104 to downgrade the pulse from the main drive pulse P12 to a main drive pulse P11, having energy one rank smaller is shown.

FIG. 8 is a table showing pulse control actions in the second embodiment of the invention, and is a table for pulse control showing determination of the rotation or non-rotation of the stepping motor 109 on the basis of a result of detection of rotation in the rotation detection term DT and actions such as permission or prohibition of the pulse-down control of the main drive pulse P1 (rank operation). A case where the rotation detection circuit 107 detects an induced signal VRs exceeding the reference threshold voltage Vcomp in the rotation detection term DT is defined as “1” and, if this is not the case, as “0”. A result of determination of the drive cycle (m seconds) immediately after a rank-down control is defined as “Determination 1”, and the result of determination of the next drive cycle (m+1 seconds, one second after) is defined as “Determination 2”, and overall determination is performed on the basis of the results of the determination 1 and the determination 2, and the rank operation is performed.

Column (a), (b), and (c) showing the state of determination in the pulse control table shown in FIG. 8 correspond to the actions in FIGS. 7A, 7B, and 7C. The pulse control table shown in FIG. 8 is stored in a storage unit (not shown) in the control circuit 103. The control circuit 103 references the pulse control table and performs the rank operation on the main drive pulse P1 on the basis of the result of detection of the rotation in the rotation detection term DT.

In FIG. 7A, in a first drive cycle T (for example, for one second) immediately after the pulse-down control from the main drive pulse P12 to the main drive pulse P11, if the control circuit 103 outputs a control signal to the main drive pulse generating circuit 104 so as to drive with the main drive pulse P11 having one of the polarities (for example, plus on the side of the terminal OUT1 and minus on the side of the terminal OUT2) during the rotating period, the main drive pulse generating circuit 104 rotates the stepping motor 109 with the main drive pulse P11 having the above-described one of the polarities via the motor drive circuit 106 in response to the control signal.

The rotation detection circuit 107 detects the induced signal VRs generated by the free vibrations of the stepping motor 109 in the rotation detection term DT immediately after the elapse of the masking term IT. The control circuit 103 determines that the stepping motor 109 is rotated if the rotation detection circuit 107 detects the induced signal VRs exceeding the predetermined reference threshold voltage Vcomp, and determines that the stepping motor 109 is not rotated if the rotation detection circuit 107 does not detect the induced signal VRs exceeding the predetermined reference threshold voltage Vcomp. In the case of FIG. 7A, it is determined that the stepping motor 109 could not be rotated with the first main drive pulse P11 after the pulse-down control because the rotation detection circuit 107 does not detect the induced signal VRs exceeding the predetermined reference threshold voltage Vcomp. Therefore, the control signal is output to the correction drive pulse generating circuit 108 to forcedly rotate the stepping motor 109 with the correction drive pulse P2 having a larger energy than the respective main drive pulse P1 and being capable of reliably rotating the stepping motor 109. Accordingly, the rotation of the stepping motor 109 is ensured.

In the next drive cycle T the control circuit 103 drives the stepping motor 109 with the main drive pulse P1 having the reverse polarity (minus on the side of the terminal OUT1, and plus on the side of the terminal OUT2) during the rotating period. However, since the stepping motor 109 could not be rotated with the first main drive pulse P11 after the pulse-down control at the time of previous driving, the control circuit 103 prohibits the pulse-down control, returns the drive pulse to the main drive pulse P12 before the pulse-down control, and drives the stepping motor 109 with the main drive pulse P12 having the reverse polarity. When prohibiting the pulse-down control, the control circuit 103 controls the pulse down counter circuit 105 so as not to output the pulse-down control signal.

In this case, the stepping motor 109 rotates, and the rotation detection circuit 107 detects the induced signal VRs exceeding the predetermined reference threshold voltage Vcomp. Therefore, the control circuit 103 determines that the stepping motor 109 could be rotated.

In the next drive cycle T, since the pulse-down control is prohibited, the stepping motor 109 is driven with the main drive pulse P12 before the pulse-down control in opposite polarities (plus on the side of the terminal OUT1 and minus on the side of the terminal OUT2). In this manner, the stepping motor 109 is driven alternatively with different polarities by the main drive pulse P12 before the pulse-down control until the next pulse-down conditions are established.

In the example shown in FIG. 7B, if the main drive pulse generating circuit 104 rotates the stepping motor 109 by the first main drive pulse P11 having one of the polarities (plus on the side of the terminal OUT1) via the motor drive circuit 106 in response to the control signal from the control circuit 103 in the first drive cycle T immediately after the pulse-down control, the control circuit 103 determines that the rotation detection circuit 107 has detected the induced signal VRs exceeding the reference threshold voltage Vcomp in the rotation detection term DT. In this case, in the next cycle T, the control circuit 103 confirms whether or not the stepping motor 109 is rotated with the first main drive pulse P11 after the pulse-down control and, in order to rotate the stepping motor 109, controls the main drive pulse generating circuit 104 so as to drive at the reverse polarity (plus on the side of the terminal OUT2) with a first drive pulse (the main drive pulse P12 before the pulse-down control in the example shown in FIG. 7B) which is capable of reliably rotating the stepping motor 109.

The main drive pulse generating circuit 104 rotates the stepping motor 109 with the drive pulse which is capable of reliably rotating the stepping motor 109 at the reverse polarity from the main drive pulse P11 after the pulse-down control (the main drive pulse P12 in the example shown in FIG. 7B) via the motor drive circuit 106 in the next cycle T. In the case of the example shown in FIG. 7B, the rotation detection circuit 107 detects the induced signal VRs exceeding the reference threshold voltage Vcomp in the rotation detection term DT. Since the stepping motor 109 is rotated with the main drive pulse P12 before the pulse-down control, which is the drive pulse being capable of reliably rotating the stepping motor 109, the control circuit 103 determines that the stepping motor 109 has been rotated by being driven with the first main drive pulse P11 after the pulse-down control.

In this manner, whether the stepping motor 109 is rotated with the drive immediately after the pulse-down control or not is determined accurately.

The control circuit 103 determines that the stepping motor 109 could be rotated with the main drive pulse P11 from then on as well, and hence permits the pulse-down control, thereby driving the stepping motor 109 alternatively by the main drive pulse P11 having different polarities until the conditions of changing the pulse rank for the next time are generated. Accordingly, the rotation with saved energy is achieved while performing the detection of rotation reliably.

In contrast, in the example shown in FIG. 7C, when the main drive pulse generating circuit 104 rotates the stepping motor 109 by the first main drive pulse P11 having one of the polarities (plus on the side of the terminal OUT1) via the motor drive circuit 106 in response to the control signal from the control circuit 103 in the first drive cycle T immediately after the pulse-down control, if the control circuit 103 determines that the rotation detection circuit 107 has detected the induced signal VRs exceeding the reference threshold voltage Vcomp in the rotation detection term DT, the control circuit 103 confirms whether the stepping motor 109 is rotated with the first main drive pulse P11 after the pulse-down control or not and, in order to rotate the stepping motor 109, controls the main drive pulse generating circuit 104 so as to drive at the reverse polarity (plus on the side of the terminal OUT2) with the drive pulse (the main drive pulse P12 before the pulse-down control in the example shown in FIG. 7C) which is capable of reliably rotating the stepping motor 109 in the next cycle T in the same manner as shown in FIG. 7B.

The main drive pulse generating circuit 104 rotates the stepping motor 109 with the main drive pulse P12 having the reverse polarity from the first main drive pulse P11 after the pulse-down control via the motor drive circuit 106 in the next cycle T. In the case of the example shown in FIG. 7C, the rotation detection circuit 107 does not detect the induced signal VRs exceeding the reference threshold voltage Vcomp in the rotation detection term DT. Since the stepping motor 109 is not rotated even with the main drive pulse P12 before the pulse-down control, which is the drive pulse being capable of reliably rotating the stepping motor 109, the control circuit 103 determines that the stepping motor 109 has not been rotated by being driven with a different polarity, that is, with the first main drive pulse P11 after the pulse-down control, and hence prohibits the pulse-down control. In this manner, whether the stepping motor 109 is rotated with the drive immediately after the pulse-down control or not is determined accurately.

In this case, the stepping motor 109 was not rotated continuously twice by being driven with the main drive pulse P11 for the last time and being driven with the main drive pulse P12 for this time. Therefore, in order to cause the stepping motor 109 to rotate twice continuously in the cycle T of this time, the control circuit 103 controls the main drive pulse generating circuit 104 so as to rotate continuously with two second drive pulses having a predetermined drive energy which is capable of reliably rotating the stepping motor 109 and having different polarities (main drive pulses P14 having a maximum drive energy in the example shown in FIG. 7C).

The main drive pulse generating circuit 104 drives the stepping motor 109 continuously with the two main drive pulses P14 having polarities different from each other via the motor drive circuit 106. When driven with the respective main drive pulses P14, the stepping motor 109 can be rotated reliably with the respective main drive pulses P14, so that the detection of rotation is not performed. Accordingly, a plurality of times of rotations can be achieved at a quick timing. In this manner, the stepping motor 109 can be rotated reliably without causing the delay of the movement of the hands.

Since the pulse-down control is prohibited as described above, the control circuit 103 controls the stepping motor 109 to be driven with the main drive pulse 12 before the pulse-down control at the reverse polarity (plus on the side of the terminal OUT1) in the next drive cycle T. The main drive pulse generating circuit 104 drives the stepping motor 109 alternatively with different polarities by the main drive pulse P12 before the pulse-down control until the next pulse-down conditions are established via the motor drive circuit 106. Accordingly, the rotation with saved energy is achieved while performing the detection of rotation reliably.

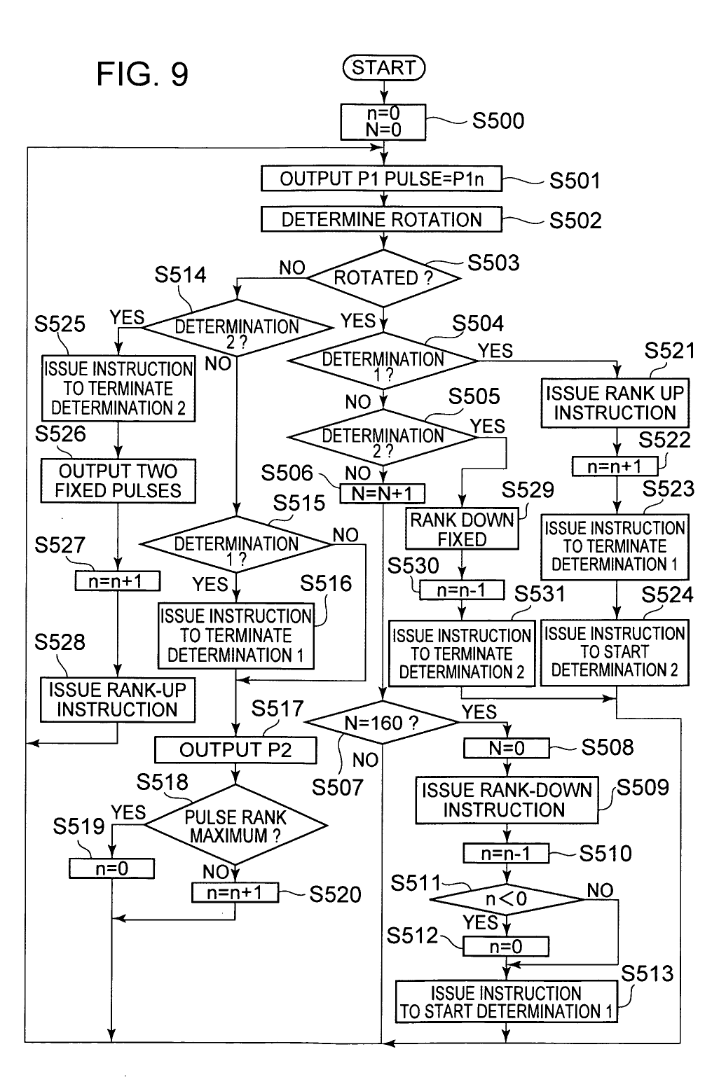

FIG. 9 is a flowchart showing an action in the second embodiment of the invention. In FIG. 9, a sign “n” designates a numerical value showing a pulse rank of the main drive pulse P1, N designates a number of times of the continuous and repetitive driving with the same main drive pulse P1 and is a count value of a PCD (Pulse Count Down) counter (not shown) in the control circuit 103. In this embodiment, if the counter counts 160 as a predetermined value of N, a control to downgrade the pulse rank of the main drive pulse P1 is performed.

Referring now to FIG. 5 to FIG. 9, the action in the second embodiment of the invention will be described.

The outline of the action will be described first. In FIG. 5, the oscillation circuit 101 generates a signal of a predetermined frequency, and the frequency divider circuit 102 divides the frequency of the signal generated by the oscillation circuit 101 and generates the clock signal as a reference of the time counting and outputs the same to the pulse down counter circuit 105 and the control circuit 103.

The control circuit 103 performs a clocking action by counting the clock signals, and outputs a main drive pulse control signal to the main drive pulse generating circuit 104 so as to drive the stepping motor 109 every time when a predetermined time period is counted.

The pulse down counter circuit 105 performs the clocking action by counting the clock signal from the frequency divider circuit 102, and outputs the pulse-down signal for downgrading the main drive pulse P1 to the main drive pulse generating circuit 104 at every predetermined cycle (for example, every time when a predetermined number of times N (160 times in this embodiment) of rotation is counted by the same main drive pulse P1) unless the pulse-down control is prohibited by the control circuit 103. The main drive pulse generating circuit 104 changes the drive pulse to the main drive pulse P1 which is downgraded by one rank in response to the pulse-down signal and outputs the same to the motor drive circuit 106. If the pulse down counter circuit 105 outputs the pulse-down signal to the main drive pulse generating circuit 104 and the main drive pulse generating circuit 104 performs the pulse-down control on the main drive pulse P1 (for example, the pulse-down control from the main drive pulse P12 to the main drive pulse P11), the control circuit 103 references the pulse control table in FIG. 8 and performs processes shown in FIGS. 7A to 7C.

The action in the second embodiment will be described in detail with reference to FIG. 9. The control circuit 103 counts the clock signal to perform the clocking action, then initializes the count for performing a pulse selection in sequence from the main drive pulse P1 having the lowest pulse rank, sets the pulse rank n of the main drive pulse P1 to a lowest rank “0” and the number of repetition of the drive pulse N to “0” (Step S500), and then outputs the control signal to rotate the stepping motor 109 with the main drive pulse P10 having a narrowest pulse width (Step S501). The drive with the main drive pulse P1 is performed by outputting the main drive pulses P1 while alternatively changing the polarities of the terminals OUT1 and OUT2 every one second.

The rotation detection circuit 107 detects the induced signal VRs generating in the stepping motor 109 and outputs the detection signal indicating whether the induced signal VRs exceeding the reference threshold voltage Vcomp is generated or not. The control circuit 103 determines whether or not the stepping motor 109 is rotated on the basis of the detection signal (Steps S502, S503).

If the control circuit 103 determines that the stepping motor 109 is not rotated, whether the state is Determination 1 or Determination 2 in FIG. 8 is confirmed (S514, S515).

The states of Determinations 1 and 2 are states immediately after the rank-down control and hence instructions of Determinations 1 and 2 are not issued in other states. Therefore, when it is not Determination 1 or even when it is Determination 1, a termination instruction is issued (Step S516) and drives the stepping motor 109 with the correction drive pulse P2 (Step S517).

The control circuit 103 has output the correction drive pulse P2 in the step S517, if the pulse rank is not the highest rank (Step S518), the pulse rank of the main drive pulse P1 is upgraded by one rank and the procedure goes to the step S501 (Step S520). If the pulse rank is already the highest rank, the pulse-up control cannot be performed any longer, and the rotation cannot be achieved with the current pulse rank. Therefore, the pulse rank is set to the lowest rank (n=0) once for saving the power consumption, and the procedure goes back to Step S501 (Step S519).

When the control circuit 103 determines that the rotation is achieved in Step S503, it determines whether it is Determination 1 or 2 (S504, S505). Since the Determinations 1 and 2 are states immediately after the rank-down control, if it is other cases, the count value of the PCD counter is incremented in Step S506.

The control circuit 103 determines the value of the PCD counter (Step S507) and, if the value N of the PCD counter is smaller than 160, drives the stepping motor 109 with the pulse rank of the current main drive pulse P1. If the value N reaches N=160, the control circuit 103 issues an instruction of the rank-down control, so that the value of N is returned back to its initial value 0 and the rank of the main drive pulse P1 is downgraded by one rank (Steps S508, S509, and S510).

The control circuit 103 confirms the lowest value of the pulse rank n of the main drive pulse P1 to avoid the pulse rank n from becoming a negative value, and issues the instruction to start the Determination 1 (Step S511 to S513).

Then, the control circuit 103 drives the stepping motor 109 again with the main drive pulse P1 after downgraded (S501). The control circuit 103 determines the rotation (Steps S502 and S503), and determines whether the state is Determinations 1 or 2 in Steps S514 and 5515 if the induced signal Vrs does not exceed the reference threshold voltage Vcomp, that is, if the stepping motor 109 is not rotated. As it is in the state of the Determination 1, the control circuit 103 issues the instruction of termination of the Determination 1 (Step S516), and outputs the correction drive pulse P2. Here, if the determination of rotation cannot be obtained in the state of the Determination 1, and the correction drive pulse P2 is output, the rank-down control is not possible. Therefore, the pulse rank is returned back to the rank before being downgraded and the determination immediately after the rank-down control is ended (see FIG. 7A, and FIG. 8A).

If it is determined that the induced signal VRs exceeding the reference threshold voltage Vcomp is detected in the state of the Determination 1 and hence the stepping motor 109 is rotated in Step S503, the control circuit 103 returns the rank of the main drive pulse P1 to the rank before being downgraded once, causes the state of the Determination 1 to be terminated, and issues the instruction to perform the Determination 2 (S504, S521 to S524) (see FIGS. 7B, 7C and FIGS. 8B and 8C).

The control circuit 103 drives the stepping motor 109 with the first drive pulse which ensures the rotation (the main drive pulse P12 before the rank-down control in this embodiment) again and determines the rotation (S501 to S503).

If the rotation is not detected in Step S503, it is now in the state of the Determination 2. Therefore, the control circuit 103 causes the Determination 2 to terminate, and drives the stepping motor 109 with the second drive pulse as a fixed pulse which is capable of reliably rotating the stepping motor 109 (the main drive pulses P14 having the maximum energy in this embodiment) two times continuously at the polarities different from each other, and issues a rank-up instruction for the pulse rank n to the main drive pulse generating circuit 104 to return the pulse rank n to the rank (n+1) before the rank-down control (S514, S525 to S528) (see FIG. 7C, FIG. 8C).

This is a process of returning the rank to a rank which has achieved the rotation before and determining again because it is not sure if the stepping motor 109 has really rotated even though it is determined to have been rotated in the determination of rotation at the time of the rank-down control. If inertia of the rotor 202 is high, an induced signal VRs exceeding the reference threshold voltage Vcomp may be detected due to the vibrations even though it is not rotated, which may be erroneously detected.

Supposing that the rotation is detected erroneously even though it is not rotated actually, if the stepping motor is driven with the main drive pulse P1 at a rank before the pulse-down control which actually has achieved the rotation, the N/S poles of the rotor 202 becomes the same, so that the induced signal VRs (>reference threshold voltage Vcomp) indicating the rotation is not given even though the pulse rank is returned back to the rank before downgrading. Accordingly, since the result of determination of “rotated” when the pulse is downgraded is error and hence the pulse-down control is impossible, the rank is returned back to the rank before. In this case, the delay of the movement of the hands by two steps occurs, the fixed pulse having short driving intervals is used to drive two steps advance to adjust the movement of the hands to the real time.

If it is determined that the rotation has occurred in Step S503 in the state of the Determination 2, the control circuit 103 permits the rank-down control and downgrades the pulse rank by one rank, and issues the instruction of terminating the Determination 2 (S529 to S531) (see FIG. 7B and FIG. 8B). The reason is as follows. When the rank-down control is performed, it is determined to be “rotated”. However, in order to confirm the likelihood of the determination, the rank is returned back to the rank which actually has achieved the rotation before and the confirmation is made again. Consequently, the result was determined to be correct. Therefore, from then onward, the stepping motor 109 is driven with different polarities from each other by the main drive pulse P1 after the pulse-down control until the next pulse rank change conditions are established.

As described above, according to the second embodiment of the invention, the stepping motor control circuit includes the rotation detection circuit 107 configured to detect the state of rotation of the stepping motor 109, and the drive control unit configured to select either one of the plurality of main drive pulses P1 having energies different from each other or the correction drive pulse P2 having energy larger than the respective main drive pulses P1 on the basis of the result of detection of rotation of the rotation detection circuit, drive the stepping motor 109 with the respective main drive pulses P1 at polarities different from each other alternatively at a predetermined cycle and drive the stepping motor 109 with the correction drive pulse P2 at the same polarity as the main drive pulse P1 immediately before in the same cycle, wherein when the stepping motor 109 is determined to be rotated by being driven with the main drive pulse P1 after the pulse-down control, and if the stepping motor 109 is still determined to be rotated by being driven with the first drive pulse which is capable of reliably rotating the stepping motor 109 in the next cycle, the drive control unit selects the main drive pulse P1 after the pulse-down control as the main drive pulse P1 to be used for driving from the next cycle onward.

Therefore, accurate detection of rotation immediately after the pulse-down control is enabled, and the delay of the display time of the watch due to the erroneous detection at the time of the pulse-down control can be prevented. Since the erroneous detection of the rotation can be prevented, an advantage such that the analogue electronic watch which is capable of driving a heavy load like a calendar load is realized with a small number of combinations of the pulse rows is achieved.

As a drive pulse which is capable of reliably rotating the stepping motor, the main drive pulse before the rank-down control, the main drive pulse having the largest energy, the correction drive pulse, or a drive pulse having a special energy can be used. If the main drive pulse before the pulse-down control is used as the drive pulse which is capable of reliably rotating the stepping motor, the drive with a minimum energy which ensures the rotation is enabled, so that the power saving is achieved.

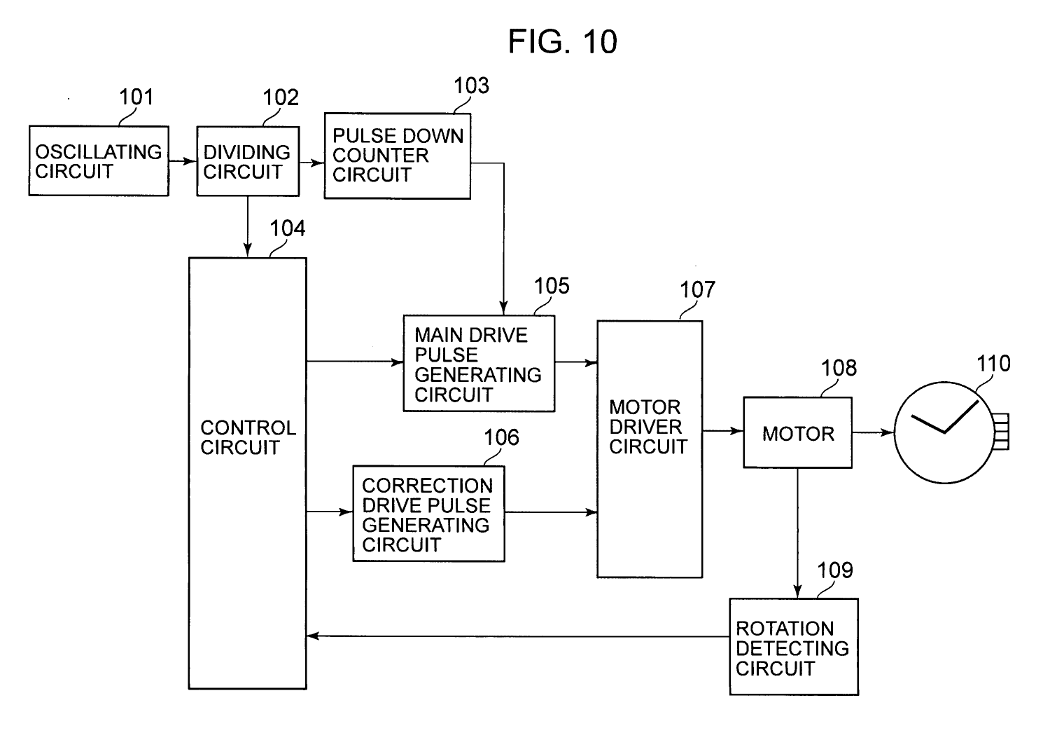

Referring now to FIG. 10 to FIG. 18, a stepping motor control circuit and an analogue electronic watch according to third and fourth embodiments of the invention will be described. In FIG. 10 to FIG. 18, the same components are designated by the same reference signs.

FIG. 10 is a block diagram of an analogue electronic watch employing a stepping motor control circuit common in the third and fourth embodiments of the invention showing an analogue electronic wrist watch.

In FIG. 10, the analogue electronic watch includes an oscillation circuit 101 configured to generate signals of a predetermined frequency, a frequency divider circuit 102 configured to divide the frequency of the signals generated in the oscillation circuit 101 and generate clock signals which serve as references of time counting, a control circuit 104 configured to control respective electronic circuit elements which constitute the electronic watch and control the change of a drive pulse, and a pulse down counter circuit 103 configured to output a pulse down control signal for downgrading a main drive pulse P1 every time when the clock signal from the frequency divider circuit 102 is counted for a predetermined time period, and start the clocking action again after having reset a counted value in response to a reset signal from the control circuit 104.

The analogue electronic watch includes a main drive pulse generating circuit 105 configured to select a main drive pulse P1 from among the plurality of main drive pulses P1 for rotating a motor on the basis of a control signal from the control circuit 104 and output the same, a correction drive pulse generating circuit 106 configured to output a correction drive pulse P2 for rotating the motor on the basis of the control signal from the control circuit 104, a motor driver circuit 107 configured to rotate a stepping motor 108 in response to the main drive pulse P1 from the main drive pulse generating circuit 105 and the correction drive pulse P2 from the correction drive pulse generating circuit 106, the stepping motor 108, an analogue display unit 110 having hands configured to be rotated by the stepping motor 108 and display the time of the day, and a rotation detection circuit 109 configured to detect an induced signal according to the rotation of the stepping motor 108 in a predetermined rotation detection term and output the same.

The control circuit 104 also has a reset function to reset the pulse down counter circuit 103 under certain conditions and restart a counting action from an initial value and a function to determine whether the stepping motor 108 is rotated or not on the basis of the fact whether the induced signal VRs detected by the stepping motor 108 exceeds a predetermined reference threshold voltage Vcomp or not. As described later, the rotation detection term for detecting whether the stepping motor 108 is rotated or not is provided in the train of a masking term (a term when the induced signal VRs is not detected) immediately after the rotation.

The rotation detection circuit 109 has the same configuration as the rotation detection circuit described in JP-B-63-018148, and is configured to detect the induced signal VRs exceeding the predetermined reference threshold voltage Vcomp if a rotor of the stepping motor 108 moves at a speed higher than the certain speed as in the case where the stepping motor 108 is rotated and not to detect the induced signal VRs exceeding the reference threshold voltage Vcomp if the rotor of the stepping motor 108 does not move at the speed higher than the certain speed as in the case where the stepping motor 108 is not rotated.

The oscillation circuit 101 and the frequency divider circuit 102 constitute a signal generating unit, and analogue display unit 110 constitutes a time-of-day display unit. The control circuit 104 constitutes a control unit and the rotation detection circuit 109 constitutes a rotation detection unit. The main drive pulse generating circuit 105 and the correction drive pulse generating circuit 106 constitute a drive pulse generating unit. The motor driver circuit 107 constitutes a motor driving unit. The oscillation circuit 101, the frequency divider circuit 102, the pulse down counter circuit 103, the control circuit 104, the main drive pulse generating circuit 105, the correction drive pulse generating circuit 106, and the motor driver circuit 107 constitute a drive control unit.

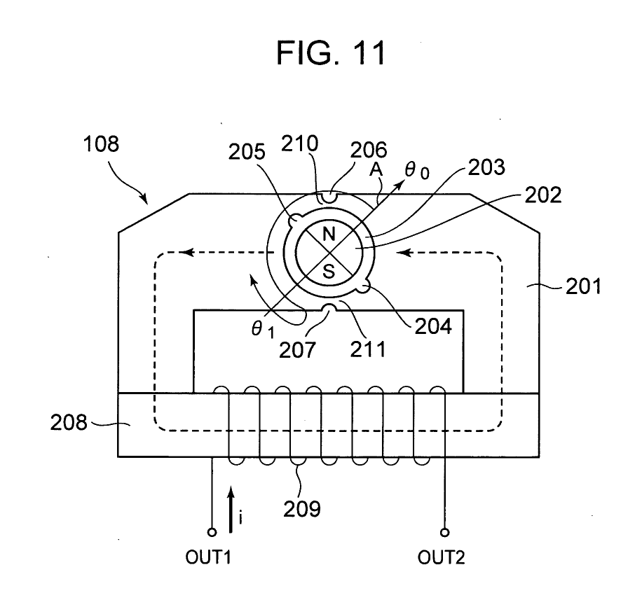

FIG. 11 is a configuration drawing of the stepping motor which is used in the third and fourth embodiments of the invention, and shows an example of a stepping motor for a watch which is generally used in the analogue electronic watch.

In FIG. 11, the stepping motor 108 includes a stator 201 having a rotor storage through hole 203, a rotor 202 disposed in the rotor storage through hole 203 so as to be capable of rotating therein, a magnetic core 208 joined to the stator 201, and a coil 209 wound around the magnetic core 208. When the stepping motor 108 is used in the analogue electronic watch, the stator 201 and the magnetic core 208 are fixed to a bottom board (not shown) with screws or caulking (not shown) and are joined to each other. The coil 209 has a first terminal OUT1 and a second terminal OUT2.

The rotor 202 is magnetized in two polarities (S-pole and N-pole). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the coil 209 is excited so that a reluctance is increased. The rotor storage through hole 203 is formed into a circular hole shape having a plurality of (two in this embodiment) semicircular notched portions (inner notches) 204 and 205 integrally formed at opposed portions of the through hole having a circular contour.

The notched portions 204 and 205 constitute positioning portions for positioning a stop position of the rotor 202. In a state in which the coil 209 is not excited, the rotor 202 is stably stopped at a position corresponding to the above-described positioning portions, in other words, at a position (position at an angle of θ0) where an axis of magnetic pole A of the rotor 202 extends orthogonally to a segment connecting the notched portions 204 and 205 as shown in FIG. 2.

When the motor driver circuit 107 supplies a square-wave drive pulse having one of the polarities between the terminals OUT1 and OUT2 of the coil 209 (for example, plus on the first terminal OUT1 side and minus on the second terminal OUT2 side), and feeds a current i in the direction indicated by an arrow in FIG. 11, a magnetic flux in the direction of an arrow of a broken line is generated in the stator 201. Accordingly, the saturable portions 210 and 211 are saturated, and the reluctance is increased, and then the rotor 202 rotates in the direction indicated by an arrow in FIG. 2 by 180° by a mutual action between a magnetic pole generated in the stator 201 and a magnetic pole of the rotor 202, and the axis of magnetic pole A stops stably at an angular position θ1. The direction of rotation (counterclockwise rotation in FIG. 11) for causing the stepping motor 108 to rotate and putting the same into a normal action (hand-moving operation because the watch in this embodiment is an analogue electronic watch) is defined to be a normal direction and the reverse direction (clockwise direction) is defined to be a reverse direction.

Subsequently, when the motor driver circuit 107 supplies a drive pulse having an opposite polarity to the terminals OUT1 and OUT2 of the coil 209 (minus on the first terminal OUT1 side and plus on the second terminal OUT2 side, so that the polarity is inverted from the driving described above), and feeds a current in the opposite direction from that indicated by an arrow in FIG. 11, a magnetic flux in the opposite direction from that indicated by an arrow of a broken line is generated in the stator 201. Accordingly, the saturable portions 210 and 211 are saturated first, and then the rotor 202 rotates in the same direction as that described above by 180° by the mutual action between the magnetic pole generated in the stator 201 and the magnetic pole of the rotor 202, and the axis of magnetic pole A stops stably at the predetermined angular position θ0.

In this manner, by supplying signals having different polarities (alternating signals) to the coil 209, the operation is repeatedly performed, so that the rotor 202 is rotated continuously in the direction indicated by the arrow by 180° each.

In this embodiment, a plurality of types of main drive pulse P1n and a correction drive pulse P2 having energies different from each other are used as the drive pulses as described later. A rank n of the main drive pulse P1n has a plurality of ranks from the minimum value 1 to a maximum value m, and the energy of the drive pulse increases with increase of the value n. The correction drive pulse P2 is a large energy pulse which is able to rotate an excessive load, and is configured to have energy larger than the respective main drive pulses P1. In this embodiment, the main drive pulse P1 uses a comb-shape main drive pulse, so that drive energy can be changed by keeping the pulse width constant and changing the duty ratio.

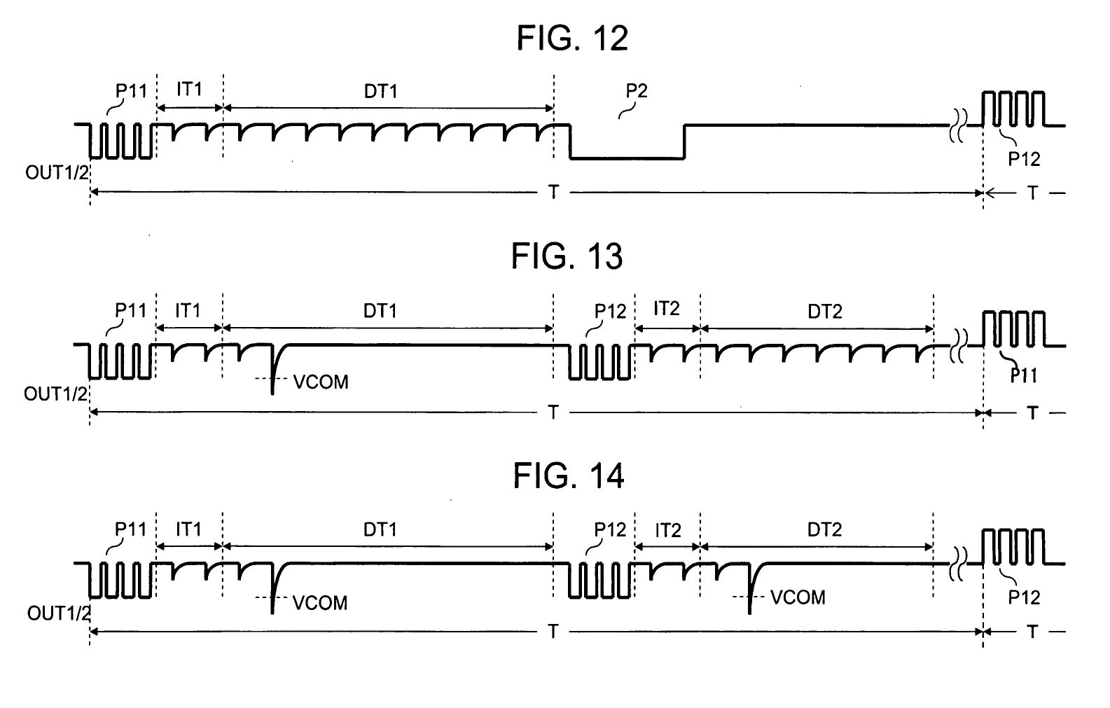

FIG. 12 to FIG. 14 are timing charts showing driving timings and rotation detecting timings, and the types of the used drive pulses of the stepping motor 108 according to a third embodiment of the invention, and also showing polarities of the drive pulse to be applied to the terminals OUT1 and OUT2. A masking term IT is provided immediately after a rotating period in which the stepping motor 108 is rotated with the main drive pulse P1, and a rotation detection term DT for detecting whether the stepping motor 108 is rotated or not is provided immediately after the masking term IT. The masking term IT is a period provided for eliminating the erroneous detection due to effects of noises or the like and is a period in which the induced signal generated by the stepping motor 108 is not detected.

In FIGS. 3 to 5, a timing after the stepping motor 108 is rotated with a main drive pulse P12, then the control circuit 104 controls the main drive pulse generating circuit 105 to downgrade the pulse from the main drive pulse P12 to a main drive pulse P11, having energy one rank smaller is shown.

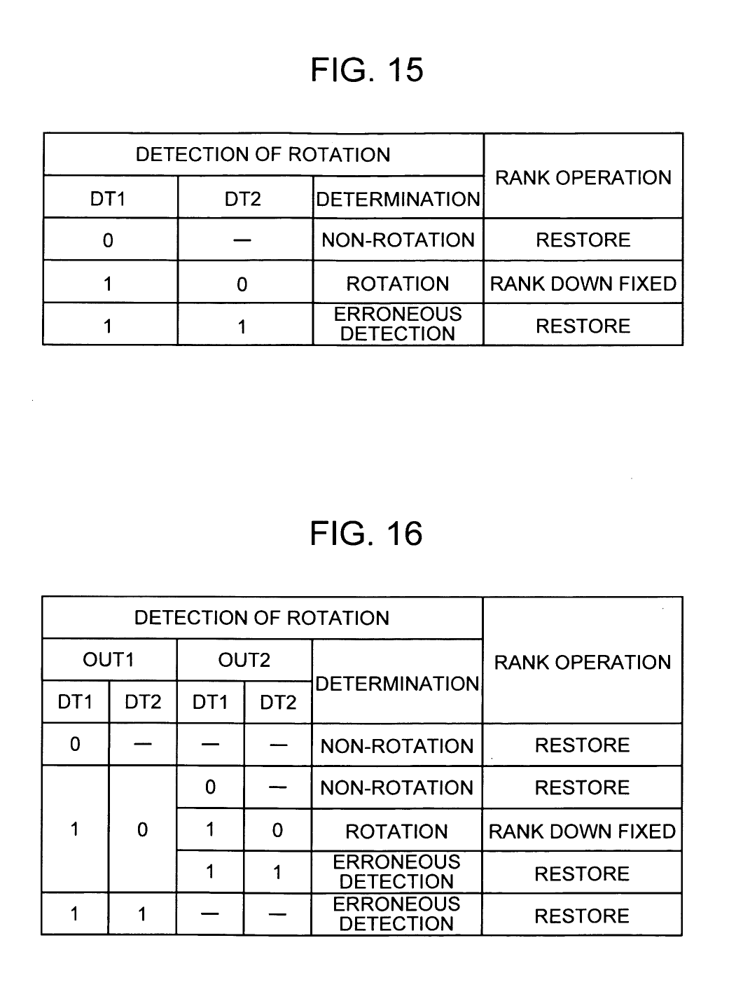

FIG. 15 is a table showing pulse control actions shown in FIGS. 12 to 14, and is a table for pulse control, which shows determination of the rotation or non-rotation of the stepping motor 108 on the basis of results of detection of rotation in rotation detection terms DT1 and DT2, and whether the permission or prohibition (rank operation) of the pulse-down control of the main drive pulse P1 is to be performed or not. A case where the rotation detection circuit 109 detects the induced signal VRs exceeding the reference threshold voltage Vcomp in the rotation detection term DT1 or DT2 is defined as “1” and, if this is not the case, as “0”. The pulse control table shown in FIG. 15 is stored in a storage unit (not shown) in the control circuit 104. The control circuit 104 references the pulse control table and performs the rank operation on the main drive pulse P1 on the basis of the results of detection of the rotation in the rotation detection terms DT1 and DT2.

In FIG. 12, in a drive cycle T (for example, for one second) immediately after the pulse-down control, if the control circuit 104 outputs a control signal to the main drive pulse generating circuit 105 so as to drive with the main drive pulse P11 having one of the polarities (for example, the plus on the side of the terminal OUT1 and minus on the side of the terminal OUT2) during the rotating period, the main drive pulse generating circuit 105 rotates the stepping motor 108 with the main drive pulse P11 having the above-described one of the polarities via the motor driver circuit 107 in response to the control signal.

The rotation detection circuit 109 detects the induced signal VRs generated by free vibrations of the stepping motor 108 in the rotation detection term DT1 in the same drive cycle T immediately after the elapse of the masking term IT1. When the rotation detection circuit 109 detects the induced signal VRs exceeding the predetermined reference threshold voltage Vcomp, the control circuit 104 determines that the stepping motor 108 is rotated, and when the rotation detection circuit 109 does not detect the induced signal VRs exceeding the predetermined reference threshold voltage Vcomp, the control circuit 104 determines that the stepping motor 108 is not rotated. However, in the case of FIG. 3C, since the rotation detection circuit 109 does not detect the induced signal VRs exceeding the predetermined reference threshold voltage Vcomp, the control circuit 104 determines that the stepping motor 108 cannot be rotated with the main drive pulse P11 after the pulse-down control, and hence forcedly rotates the stepping motor 108 with the correction drive pulse P2 having energy larger than the respective main drive pulses P1, which is energy being capable of reliably rotating the stepping motor 108. Accordingly, the rotation of the stepping motor 108 is ensured.

In the next drive cycle T the control circuit 104 drives the stepping motor 109 with the main drive pulse P1 having the reverse polarity (for example, minus on the terminal OUT1 side, and plus on the terminal OUT2 side) during the rotating period. However, since the stepping motor 109 could not be rotated with the main drive pulse P11 after the pulse-down control at the time of previous driving, the control circuit 104 prohibits the pulse-down control, returns the drive pulse to the main drive pulse P12 before the pulse-down control, and drives the stepping motor 108 with the main drive pulse P12 having the reverse polarity.

In the drive cycle T immediately after the pulse-down control shown in FIG. 13, if the control circuit 104 determines that the rotation detection circuit 109 detects the induced signal VRs exceeding the reference threshold voltage Vcomp in the rotation detection term DT1 when the motor driver circuit 107 rotates the stepping motor 108 with the main drive pulse P11 having one of the polarities in response to the control signal from the control circuit 104, the control circuit 104 controls the main drive pulse generating circuit 105 to rotate the stepping motor 108 with a confirmation drive pulse (the main drive pulse P12 before the pulse-down control in the example shown in FIG. 13) having a driving energy which is capable of reliably rotating the stepping motor 108 at the same polarity as the main drive pulse P11 after the pulse-down control in the same drive cycle T.

The main drive pulse generating circuit 105 rotates the stepping motor 108 with the main drive pulse P12 having the same polarity as the main drive pulse P11 after the pulse-down control via the motor driver circuit 107 in the same drive cycle T. In the case of the example shown in FIG. 13, the rotation detection circuit 109 does not detect the induced signal VRs exceeding the reference threshold voltage Vcomp in the rotation detection term DT2 within the same drive cycle T. Since the stepping motor 108 is rotated with the main drive pulse P11 after the pulse-down control, the control circuit 104 determines that the stepping motor 108 has not been rotated by being driven with the main drive pulse P12 having the same polarity as the main drive pulse P11. In this manner, whether the stepping motor 108 is rotated with the drive immediately after the pulse-down control or not is determined accurately. The control circuit 104 determines that the rotation can be achieved with the main drive pulse P11 also from then onward, and permits the pulse-down control.

In the next drive cycle T the control circuit 104 drives the stepping motor 109 with the main drive pulse P1 having the reverse polarity during the rotating period. However, since the stepping motor 109 could be rotated with the main drive pulse P11 after the pulse-down control at the time of previous driving, the control circuit 104 drives the stepping motor 108 with the main drive pulse P11 after the pulse-down control at the reverse polarity. Accordingly, the stepping motor 108 can be rotated while achieving the power saving.

In contrast, in the drive cycle T immediately after the pulse-down control shown in FIG. 14, if the control circuit 104 determines that the rotation detection circuit 109 detects the induced signal VRs exceeding the reference threshold voltage Vcomp in the rotation detection term DT1 when the motor driver circuit 107 rotates the stepping motor 108 with the main drive pulse P11 having one of the polarities in response to the control signal from the control circuit 104, the control circuit 104 controls the main drive pulse generating circuit 105 to rotate the stepping motor 108 with a confirmation drive pulse (the main drive pulse P12 before the pulse-down control in the example shown in FIG. 14) having a driving energy which is capable of reliably rotating the stepping motor 108 at the same polarity as the main drive pulse P11 after the pulse-down control in the same drive cycle T as in FIG. 13.

The main drive pulse generating circuit 105 rotates the stepping motor 108 with the main drive pulse P12 having the same polarity as the main drive pulse P11 after the pulse-down control via the motor driver circuit 107. In the case of the example shown in FIG. 14, the rotation detection circuit 109 detects the induced signal VRs exceeding the reference threshold voltage Vcomp in the rotation detection term DT2 within the same drive cycle T. Since the stepping motor 108 is not rotated with the main drive pulse P11 after the pulse-down control, the control circuit 104 determines that the stepping motor 108 has been rotated by being driven with the main drive pulse P12 having the same polarity as the main drive pulse P11. In this manner, whether the stepping motor 108 is rotated with the driving immediately after the pulse-down control or not is determined accurately. The control circuit 104 determines that the rotation cannot be achieved with the main drive pulse P11, and prohibits the pulse-down control.

In the next drive cycle T the control circuit 104 drives the stepping motor 109 with the main drive pulse P1 having the reverse polarity during the rotating period. However, since the stepping motor 109 could not be rotated with the main drive pulse P11 after the pulse-down control at the time of previous driving, the control circuit 104 prohibits the pulse-down control and drives the stepping motor 108 while returning the main drive pulse to the main drive pulse P12 before the pulse-down control at the reverse polarity. Accordingly, the stepping motor 108 can be rotated reliably.

FIG. 17 is a flowchart showing an action in the third embodiment of the invention.

Referring now to FIGS. 10 to 15 and FIG. 17, the action in the third embodiment of the invention will be described in detail.

In FIG. 10, the oscillation circuit 101 generates a signal of a predetermined frequency, and the frequency divider circuit 102 divides the frequency of the signal generated by the oscillation circuit 101 and generates a clock signal as a reference of time counting and outputs the same to the pulse down counter circuit 103 and the control circuit 104.

The control circuit 104 performs a clocking action by counting the clock signals, and outputs a main drive pulse control signal to the main drive pulse generating circuit 105 so as to drive the stepping motor 108 every time when a predetermined time period is counted.

The pulse down counter circuit 103 performs the clocking action by counting the clock signal from the frequency divider circuit 102, and outputs the pulse-down signal for downgrading the main drive pulse P1 to the main drive pulse generating circuit 105 at every predetermined cycle. The main drive pulse generating circuit 105 changes the drive pulse to the main drive pulse P1 which is downgraded by one rank in response to the pulse-down signal and outputs the same to the motor driver circuit 107.

If the pulse down counter circuit 103 outputs the pulse-down signal to the main drive pulse generating circuit 105 and the main drive pulse generating circuit 105 performs the pulse-down control on the main drive pulse P1 (for example, the pulse-down control from the main drive pulse P12 to the main drive pulse P11), the control circuit 104 performs processes shown in FIG. 17.

The main drive pulse generating circuit 105 outputs the main drive pulse P11 after the pulse-down control to the motor driver circuit 107 in response to the control signal from the control circuit 104 (Step S801). The motor driver circuit 107 rotates the stepping motor 108 with the main drive pulse P11. The stepping motor 108 is rotated with the main drive pulse P11 and drives the analogue display unit 110. Accordingly, when the stepping motor 108 is normally rotated, the current time-of-day display or the like by the time-of-day hands is achieved by the analogue display unit 110.

The rotation detection circuit 109 outputs a detection signal indicating whether or not the induced signal VRs exceeding the reference threshold voltage Vcomp is detected in the rotation detection term DT1 to the control circuit 104.

When the control circuit 104 determines that the rotation detection circuit 109 does not detect the induced signal VRs exceeding the reference threshold voltage Vcomp, that is, that the stepping motor 108 has not been rotated (Step S802) in the rotation detection term DT1, the control circuit 104 outputs the control signal to the correction drive pulse generating circuit 106 to drive with the correction drive pulse P2 having the same polarity as the main drive pulse P11 (Step S803).

The correction drive pulse generating circuit 106 controls the motor driver circuit 107 so as to rotate the stepping motor 108 with the correction drive pulse P2 having the same polarity as the main drive pulse P11 as shown in FIG. 12 in response to the control signal. The motor driver circuit 107 drives the stepping motor 108 with the correction drive pulse P2 having the same polarity, whereby the analogue display unit 110 is driven and the current time-of-day display or the like by the time-of-day hands is achieved.

Subsequently, the control circuit 104 upgrades the main drive pulse P1 (Step S804). The control circuit 104 performs the next driving with the upgraded main drive pulse P12 having the reverse polarity.

If the control circuit 104 determines that the rotation detection circuit 109 detects the induced signal VRs exceeding the reference threshold voltage Vcomp, that is, that the stepping motor 108 is rotated in Step S802, the control circuit 104 upgrades the main drive pulse P11 to a confirmation drive pulse having a drive energy which is capable of reliably rotating the stepping motor 108 (the main drive pulse P12 in this embodiment) (Step S805), and controls the main drive pulse generating circuit 105 so as to drive the stepping motor 108 with the upgraded main drive pulse P12 having the same polarity as shown in FIG. 4 (Step S806). The main drive pulse generating circuit 105 rotates the stepping motor 108 with the main drive pulse P12 via the motor driver circuit 107.

The rotation detection circuit 109 outputs a detection signal indicating whether or not the induced signal VRs exceeding the reference threshold voltage Vcomp is detected in the rotation detection term DT2 in the same drive cycle T as the rotation detection term DT1 to the control circuit 104.

When the control circuit 104 determines that the rotation detection circuit 109 does not detect the induced signal VRs exceeding the reference threshold voltage Vcomp, that is, that the stepping motor 108 has not been rotated (Step S807) in the rotation detection term DT2, the control circuit 104 determines that the stepping motor 108 is rotated by being driven with the main drive pulse P11, permits the pulse-down control, and fixes the pulse thereto (Step S808).

If the control circuit 104 determines that the rotation detection circuit 109 detects the induced signal VRs exceeding the reference threshold voltage Vcomp, that is, that the stepping motor 108 is rotated in Step S807, the control circuit 104 determines that the result of detection in Step S802 is an erroneous detection and that the stepping motor 108 has not been rotated by being driven with the main drive pulse P11, and hence prohibits the pulse-down control, and then returns the drive pulse to the original main drive pulse P12 and fixes the pulse thereto. Then the process in this drive cycle T is terminated. The normal driving action is performed from the driving of the stepping motor 108 with the next main drive pulse P1 onward.

As described above, in the stepping motor control circuit including the rotation detection circuit 109 configured to detect whether or not the induced signal VRs generated by the rotation of the stepping motor 108 exceeds the predetermined reference threshold voltage Vcomp and a drive control unit configured to determine whether or not the stepping motor 108 is rotated on the basis of the result of detection by the rotation detection circuit 109, changes the main drive pulse into one of the plurality of types of the main drive pulses P1 having energies different from each other on the basis of the result of determination, and controls the drive of the stepping motor 108 alternately with different polarities, the drive control unit is configured to determine whether or not the stepping motor 108 is rotated by being driven with the main drive pulse P1 after the pulse-down control on the basis of the result of detection of the drive with the main drive pulse P1 after the pulse-down control and the result of detection when being driven with a confirmation drive pulse which has the same polarity as the main drive pulse P1 after the pulse-down control and is capable of reliably rotating the stepping motor 108.

After having driven the stepping motor 108 with the main drive pulse P1 for the first time after the pulse-down control, the stepping motor 108 is subsequently driven with the confirmation drive pulse having the same polarity as the main drive pulse P1 and a drive energy which is capable of reliably rotating the stepping motor. If the stepping motor 108 is rotated with the main drive pulse P1 after the pulse-down control, it corresponds to a sucking operation, and hence the stepping motor 108 is not rotated with the subsequent driving with the confirmation drive pulse. Therefore, the induced signal VRs exceeding the reference threshold voltage Vcomp is not generated. In contrast, if the stepping motor 108 is not rotated with the main drive pulse P1 after the pulse-down control, the stepping motor 108 is rotated with the subsequent driving with the confirmation drive pulse. Therefore, the induced signal VRs exceeding the reference threshold voltage Vcomp is generated. Therefore, by determining whether the stepping motor 108 is rotated or not rotated on the basis of the generation of the induced signal VRs exceeding the reference threshold voltage Vcomp, the accurate detection of rotation is enabled, and the erroneous detection of rotation can be prevented.

If the stepping motor 108 is not rotated with the main drive pulse, the induced signal VRs exceeding the reference threshold voltage Vcomp is generated by being driven with the confirmation drive pulse which absolutely causes the rotation, the stepping motor 108 can be rotated with the optimal main drive pulse P1 which is smaller than the correction drive pulse P2, whereby the rotation is ensured and the power saving is achieved. In addition, by performing the detection of rotation immediately after the pulse-down control, the accurate pulse control action is enabled.

The stepping motor control circuit and the analogue electronic watch according to a fourth embodiment of the invention will be described.

In the third embodiment, the accurate pulse control is performed by preventing the erroneous detection of rotation on the basis of the result of detection of the drive with the main drive pulse P1 and the result of detection of the drive with the confirmation drive pulse having the same polarity. In the fourth embodiment, whether or not the stepping motor is rotated with the main drive pulse after the pulse-down control is determined on the basis of the result of detection of the drive with the main drive pulse after the pulse-down control and the result of detection of the drive by the confirmation drive pulse which is capable of reliably rotating the stepping motor at the same polarity as the main drive pulse after the pulse-down control at both polarities, thereby preventing the erroneous detection of rotation and performing the pulse control.

In the fourth embodiment, the block diagram and the configuration of the stepping motor 108 are the same as FIG. 10 and FIG. 11.

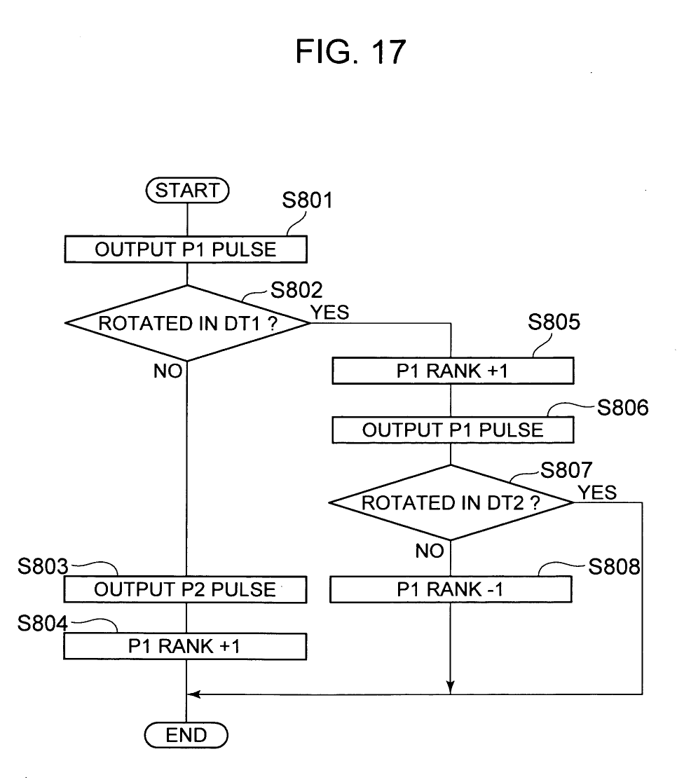

FIG. 16 is a pulse control table showing the pulse control actions according to the fourth embodiment, and including the result of detection of rotation, the determination whether rotated or not, and the rank operation in a case where the stepping motor 108 is rotated by being supplied with a drive pulse having one of the polarities and a drive pulse having a reverse polarity respectively to the terminals OUT1 and OUT2.

In FIG. 16, a case where the rotation detection circuit 109 detects an induced signal VRs exceeding the reference threshold voltage Vcomp in the rotation detection terms DT1 and DT2 is defined as “1” and, if this is not the case, as “0” as in FIG. 15. The pulse control table shown in FIG. 16 is stored in a storage unit (not shown) in the control circuit 104. The control circuit 104 references the pulse control table and performs the rank operation on the main drive pulse P1 on the basis of the results of detection of the rotation in the rotation detection terms DT1 and DT2 having both polarities.

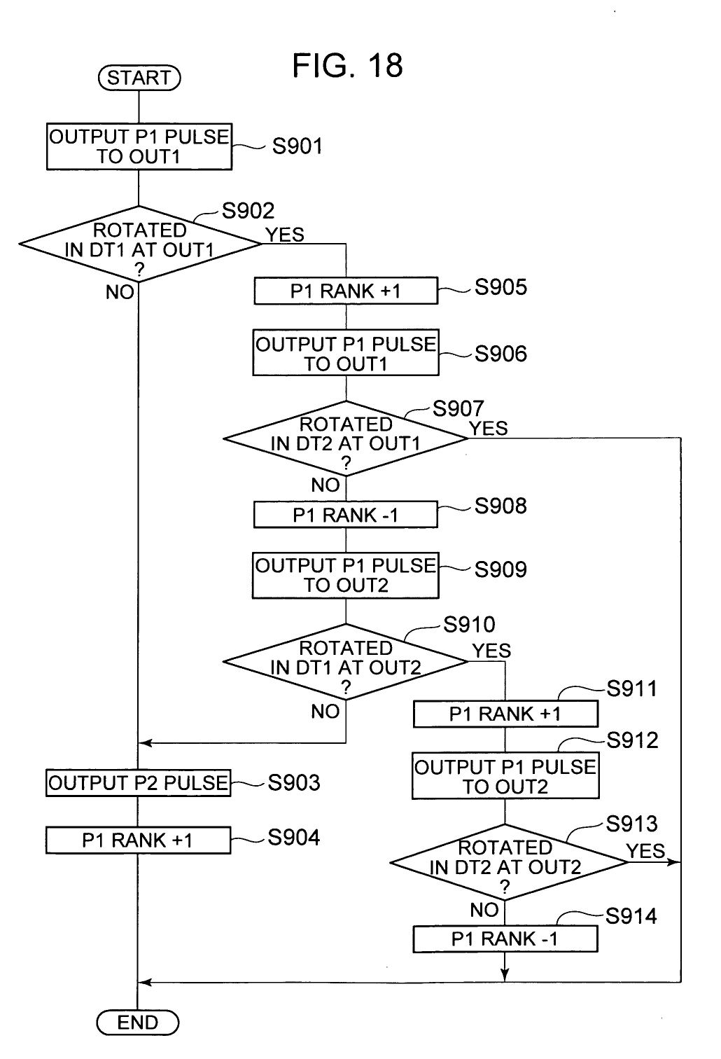

FIG. 18 is a flowchart showing an action in the fourth embodiment.

Referring now to FIGS. 10, 11, 16, and 18, parts of the actions in the fourth embodiment different from those in the third embodiment will be described.

If the pulse down counter circuit 103 outputs the pulse-down signal to the main drive pulse generating circuit 105 and the main drive pulse generating circuit 105 performs the pulse-down control on the main drive pulse P1 (for example, the pulse-down control from the main drive pulse P12 to the main drive pulse P11), the control circuit 104 performs processes shown in FIG. 9.

The main drive pulse generating circuit 105 outputs the main drive pulse P11 after the pulse-down control having one of the polarities (plus for the terminal OUT1 side and minus for the terminal OUT2 side in the example shown in FIG. 18) to the motor driver circuit 107 in response to the control signal from the control circuit 104 (Step S901). The motor driver circuit 107 rotates the stepping motor 108 by the main drive pulse P11 being plus on the side of the terminal OUT1. The stepping motor 108 is rotated by the main drive pulse P11 and drives the analogue display unit 110. Accordingly, when the stepping motor 108 is normally rotated, the current time-of-day display or the like by the time-of-day hands is achieved by the analogue display unit 110.

The rotation detection circuit 109 outputs a detection signal indicating whether or not the induced signal VRs exceeding the reference threshold voltage Vcomp is detected in the rotation detection term DT1 having the one of the polarities (plus for the terminal OUT1 side and minus for the terminal OUT2 side in the example shown in FIG. 18) to the control circuit 104.

When the control circuit 104 determines that the rotation detection circuit 109 does not detect the induced signal VRs exceeding the reference threshold voltage Vcomp, that is, that the stepping motor 108 has not been rotated (Step S902) in the rotation detection term DT1 having the one of the polarities, the control circuit 104 outputs a control signal to the correction drive pulse generating circuit 106 to drive with the correction drive pulse P2 having the same polarity as the main drive pulse P11 (Step S903).

The correction drive pulse generating circuit 106 controls the motor driver circuit 107 so as to rotate the stepping motor 108 with the correction drive pulse P2 at the same polarity as the main drive pulse P11 as shown in FIG. 12 in response to the control signal. The motor driver circuit 107 drives the stepping motor 108 with the correction drive pulse P2 having the same polarity, whereby the analogue display unit 110 is driven and the current time-of-day display or the like by the time-of-day hands is achieved.

Subsequently, the control circuit 104 upgrades the main drive pulse P1 (Step S904). The control circuit 104 performs the next driving with the upgraded main drive pulse P12 having the reverse polarity.

If the control circuit 104 determines that the rotation detection circuit 109 detects the induced signal VRs exceeding the reference threshold voltage Vcomp, that is, that the stepping motor 108 is rotated in Step S902, the control circuit 104 upgrades the main drive pulse P11 to a confirmation drive pulse having a drive energy which is capable of reliably rotating the stepping motor 108 (the main drive pulse P12 in the fourth embodiment) (Step S905), and controls the main drive pulse generating circuit 105 so as to drive the stepping motor 108 with the upgraded main drive pulse P12 having the same polarity as shown in FIG. 13 (Step S906). The main drive pulse generating circuit 105 rotates the stepping motor 108 with the main drive pulse P12 having the same polarity as the one of the polarities after the pulse-up control via the motor driver circuit 107.

The rotation detection circuit 109 outputs a detection signal indicating whether or not the induced signal VRs exceeding the reference threshold voltage Vcomp is detected in the rotation detection term DT2 in the drive cycle T having the one of the polarities to the control circuit 104.

When the control circuit 104 determines that the rotation detection circuit 109 does not detect the induced signal VRs exceeding the reference threshold voltage Vcomp, that is, that the stepping motor 108 has not been rotated (Step S907) in the rotation detection term DT2 having the one of the polarities in the drive cycle T, the control circuit 104 determines that the stepping motor 108 is rotated by being driven with the main drive pulse P11 and performs the pulse-down control (Step S908), and controls the main drive pulse generating circuit 105 to drive with the main drive pulse P11 having the other polarity (reverse polarity) (Step S909). The main drive pulse generating circuit 105 rotates the stepping motor 108 with the main drive pulse P11 having the reverse polarity via the motor driver circuit 107.

Subsequently, if the control circuit 104 determines that the rotation detection circuit 109 does not detect the induced signal VRs exceeding the reference threshold voltage Vcomp, that is, that the stepping motor 108 has not been rotated in the rotation detection term DTI in the drive cycle T having the reverse polarity, the procedure goes to Step S903 (Step S910).

If the control circuit 104 determines that the rotation detection circuit 109 detects the induced signal VRs exceeding the reference threshold voltage Vcomp, that is, that the stepping motor 108 is rotated in Step S910, the control circuit 104 upgrades the main drive pulse P11 to a confirmation drive pulse having a drive energy which is capable of reliably rotating the stepping motor 108 (the main drive pulse P12 in the fourth embodiment) (Step S911) in the same manner as in FIG. 13, and controls the main drive pulse generating circuit 105 so as to drive the stepping motor 108 with the upgraded main drive pulse P12 having the reverse polarity (Step S912). The main drive pulse generating circuit 105 rotates the stepping motor 108 with the main drive pulse P12 having the reverse polarity after the pulse-up control via the motor driver circuit 107.

The rotation detection circuit 109 outputs a detection signal indicating whether or not the induced signal VRs exceeding the reference threshold voltage Vcomp is detected in the rotation detection term DT2 in the drive cycle T having the reverse polarity to the control circuit 104.

If the control circuit 104 determines that the rotation detection circuit 109 does not detect the induced signal VRs exceeding the reference threshold voltage Vcomp, that is, that the stepping motor 108 has not been rotated (Step S913) in the rotation detection term DT2 having the reverse polarity in the drive cycle T, the control circuit 104 determines that the stepping motor 108 is rotated by being driven in Step S909, permits the pulse-down control, and fixes the pulse (Step S914).

If the control circuit 104 determines that the rotation detection circuit 109 detects the induced signal VRs exceeding the reference threshold voltage Vcomp, that is, that the stepping motor 108 is rotated in Step S913, the control circuit 104 determines that the stepping motor 108 has not been rotated by being driven in Step S909, and hence prohibits the pulse-down control, and then returns the pulse to the original main drive pulse P12 and fixes the pulse thereto. If the control circuit 104 determines that the rotation detection circuit 109 detects the induced signal VRs exceeding the reference threshold voltage Vcomp, that is, that the stepping motor 108 is rotated in Step S907, the control circuit 104 determines that the stepping motor 108 has not been rotated by being driven in Step S902, and hence prohibits the pulse-down control, and then returns the pulse to the original main drive pulse P12 and fixes the pulse thereto. In this case, the drive with the main drive pulse P1 is performed with the main drive pulse P12 until the next pulse-down control is performed by the pulse down counter circuit 103.

As described above, according to the fourth embodiment, when the stepping motor is driven with the main drive pulse P1 for the first time after the pulse-down control, and if the stepping motor is not rotated at the same polarity as the main drive pulse P1 subsequently, whether or not the stepping motor is rotated is determined by being driven with the drive pulse which is capable of absolutely rotating the same. Therefore, advantages such that the erroneous detection of rotation is prevented and so on are achieved as in the first embodiment.

Whether or not the stepping motor is rotated is determined on the basis of the result of rotation at the both polarities. Therefore, the erroneous detection of rotation can be prevented. Advantages such that the accurate pulse control is enabled, the reliable rotation is ensured, the power saving is enabled and so on are achieved.

In the third and fourth embodiments, the main drive pulse before the pulse-down control is used as the drive pulse which ensures the reliable rotation. However, a drive pulse larger than the main drive pulse after the rank-down control may be used. Since the main drive pulse before the pulse-down control is used as the drive pulse which is capable of reliably rotating the stepping motor, the drive with a minimum energy which ensures the rotation is enabled, so that the power saving is achieved.

It is possible to use the comb-shape main drive pulse as the main drive pulse P1, and change the drive energy by maintaining the pulse width constant and changing the duty ratio. However, the drive energy may also be changed by maintaining the duty ratio constant and changing the number of comb teeth (in this case, the pulse width is changed), or by changing the pulse voltage. It is also possible to use the square-wave main drive pulse. Alternatively, the pulse width may be changed for changing the drive energies of the respective drive pulses.

The invention is also applicable to the stepping motor for driving a calendar or a chronograph hand or the like instead of the time-of-day hands.

Also, although the analogue electronic watch has been described as the example of the application of the stepping motor, it may be applicable to electronic instruments which use the motor.

The stepping motor control circuit according to the invention may be applicable to various electronic instruments using the stepping motor.

The electronic watch according to the invention is applicable to various analogue electronic clocks including various analogue electronic clocks with a calendar function such as analogue electronic watches with a calendar function, analogue electronic standing clocks with a calendar function, or chronograph watches.

What is claimed is:

1. A stepping motor control circuit comprising:
a rotation detection unit configured to detect whether or not an induced signal generated by a rotation of a stepping motor exceeds a predetermined reference threshold voltage; and
a drive control unit configured to determine whether or not the stepping motor is rotated on the basis of a result of detection by the rotation detection unit, change a main drive pulse into one of a plurality of types of the main drive pulses having energies different from each other on the basis of a result of the determination, and control the drive of the stepping motor alternately with different polarities,
wherein the drive control unit determines whether or not the stepping motor is rotated by being driven with the main drive pulse after a pulse-down control on the basis of the result of detection of the drive with the main drive pulse after the pulse-down control and the result of detection when being driven with a drive pulse which is output next to the main drive pulse after the pulse-down control and is capable of reliably rotating the stepping motor.

2. A stepping motor control circuit according to claim 1, wherein the rotation detection unit detects a state of rotation on the basis of a current flowing through the stepping motor when the stepping motor is driven with a correction drive pulse immediately after having driven the same with the first main drive pulse after the pulse-down control, and
the drive control unit drives the stepping motor with the correction drive pulse immediately after having drive the same with the first main drive pulse after the pulse-down control, and selects the main drive pulse to be used for the next time on the basis of the result of detection by the rotation detection unit when being driven with the correction drive pulse.

3. A stepping motor control circuit according to claim 2, wherein in a case where the rotation detection unit compares a current value flowing through the stepping motor with a threshold value when the stepping motor is driven with the correction drive pulse immediately after having driven the same with the first main drive pulse after the pulse-down control, if the current value exceeds the threshold value, the rotation detection unit determines that the stepping motor is rotated with the main drive pulse and, if the current value does not exceed the threshold value, the rotation detection unit determines that the stepping motor is not rotated with the main drive pulse, and detects the state of rotation.

4. A stepping motor control circuit according to claim 2, wherein in a case where the stepping motor is driven with the correction drive pulse immediately after having driven with the first main drive pulse after the pulse-down control and if the drive control unit determines that the stepping motor is rotated with the main drive pulse on the basis of the result of detection of the rotation detection unit, the drive control unit selects the main drive pulse after the pulse-down control as the main drive pulse used for the next driving.

5. A stepping motor control circuit according to claim 2, wherein in a case where the stepping motor is driven with the correction drive pulse immediately after having driven with the first main drive pulse after the pulse-down control and if the drive control unit determines that the stepping motor is not rotated with the main drive pulse on the basis of the result of detection of the rotation detection unit, the drive control unit selects the main drive pulse having a larger energy before the pulse-down control as the main drive pulse used for the next driving.

6. A stepping motor control circuit according to claim 2, wherein the first main drive pulse after the pulse-down control and the correction drive pulse to be used for driving immediately after having driven with the main drive pulse are drive pulses having the same polarity.

7. A stepping motor control circuit according to claim 2, wherein the rotation detection unit detects the state of rotation of the stepping motor on the basis of the induced signal generated by free vibrations of the stepping motor immediately after having driven when the stepping motor is driven with the main drive pulse other than the first main drive pulse after the pulse-down control.

8. A stepping motor control circuit according to claim 1, wherein in a case where the drive control unit determines that the stepping motor is rotated by being driven with the first main drive pulse after the pulse-down control, if the drive control unit determines that the stepping motor is rotated by being driven with a first drive pulse which is capable of reliably rotating the stepping motor in a next cycle, the drive control unit selects the main drive pulse after the pulse-down control as the main drive pulse used for driving from the next cycle onward.

9. A stepping motor control circuit according to claim 8, wherein in a case where the drive control unit determines that the stepping motor is rotated by being driven with the first main drive pulse after the pulse-down control, if the drive control unit determines that the stepping motor is not rotated by being driven with the first drive pulse in the next cycle, the drive control unit drives the stepping motor twice continuously with a second drive pulse which is capable of reliably rotating the stepping motor in the same cycle as the first drive pulse.

10. A stepping motor control circuit according to claim 9, wherein the rotation detection unit does not detect the rotation of the stepping motor when the stepping motor is driven with the second drive pulse.

11. A stepping motor control circuit according to claim 9, wherein the second drive pulse is a main drive pulse having a maximum energy.

12. A stepping motor control circuit according to claim 8, wherein if the drive control unit determines that the stepping motor is rotated by being driven with the first main drive pulse after the pulse-down control and that the stepping motor is not rotated by being driven with the first drive pulse in the next cycle, and drives the stepping motor twice continuously with the second drive pulse which is capable of reliably rotating the stepping motor in the same cycle as the first drive pulse, the drive control unit selects the main drive pulse after the pulse-down control as the main drive pulse to be used for driving from the next cycle onward.

13. A stepping motor control circuit according to claim 8, wherein the first drive pulse is a main drive pulse before a rank-down control.

14. A stepping motor control circuit according to claim 1, wherein the drive control unit determines whether or not the stepping motor is rotated by being driven with the main drive pulse after the pulse-down control on the basis of the result of detection when being driven with the main drive pulse after the pulse-down control and the result of detection when being driven with the confirmation drive pulse which is capable of reliably rotating the stepping motor at the same polarity as the main drive pulse after the pulse-down control.

15. A stepping motor control circuit according to claim 14, wherein in a case where the drive control unit determines that the stepping motor is rotated by being driven with the main drive pulse after the pulse-down control, if the drive control unit drives the stepping motor with the confirmation drive pulse which is capable of reliably rotating the stepping motor at the same polarity as the main drive pulse after the pulse-down control and determines that the stepping motor is not rotated by being driven with the confirmation drive pulse, the drive control unit determines that the stepping motor is rotated by being driven with the main drive pulse after the pulse-down control and, if drive control unit determines that the stepping motor is rotated by being driven with the confirmation drive pulse, the drive control unit determines that the stepping motor is not rotated by being driven with the main drive pulse after the pulse-down control.

16. A stepping motor control circuit according to claim 14, wherein the drive control unit determines whether or not the stepping motor is rotated by being driven with the main drive pulse after the pulse-down control on the basis of the result of detection when being driven with the main drive pulse after the pulse-down control and the result of detection when being driven with the confirmation drive pulse which is capable of reliably rotating the stepping motor at the same polarity as the main drive pulse after the pulse-down control at both polarities.

17. A stepping motor control circuit according to claim 16, wherein in a case where determination of the rotation is performed by driving the stepping motor with the main drive pulse after the pulse-down control and the confirmation drive pulse at both polarities, and if the drive control unit determines that the stepping motor is rotated by being driven with the main drive pulse after the pulse-down control and that the stepping motor is not rotated by being driven with the confirmation drive pulse at both polarities, the drive control unit determines that the stepping motor is rotated by being driven with the main drive pulse after the pulse-down control and, in other cases, determines that the stepping motor is not rotated by being driven with the main drive pulse after the pulse-down control.

18. A stepping motor control circuit according to claim 14, wherein the confirmation drive pulse has the same drive energy as the main drive pulse before the pulse-down control.

19. A stepping motor control circuit according to claim 14, wherein driving with the main drive pulse after the pulse-down control and driving with the confirmation drive pulse corresponding to the main drive pulse are performed in the same drive cycle.

20. An analogue electronic watch having a stepping motor configured to rotate a time-of-day hand, and a stepping motor control circuit configured to control the stepping motor, wherein the stepping motor control circuit according to claim 1 is used as the stepping motor control circuit.
